(19) United States
(12) Patent Application Publication
(10) Pub. No.: US 2005/0166731 A1
(43) Pub. Date: Aug. 4, 2005

(54) Rotary saw table and method for adapting various rotary saws to rotary saw table

(76) Inventor: William Randolph Jones, Broken Arrow, OK (US)

Correspondence Address: WILLIAM RANDOLPH JONES, 1804 SOUTH FIR AVENUE, BROKEN ARROW, OK, 74012, US

(21) Appl. No.: 11/044,581

(22) Filed: Jan. 27, 2005

Related U.S. Application Data
(60) Provisional application No. 60/540,017, filed on Jan. 29, 2004.

(51) Int. Cl. B26D 1/00; B26D 1/12

(52) U.S. Cl. 83/13; 83/663

(57) ABSTRACT

A rotary saw table and method for adapting various rotary saws of the subject invention provides for greatly improved ease in cutting, sawing, and sanding in a multitude of applications. The rotary saw table and method for adapting various rotary saws allows for the cutting of various materials, including wood products and wall tile, in support of arts and crafts, home projects, and various hobbies while completely eliminating the limiting overhead arm assembly found on jigsaws and band saws. The rotary saw table and method for adapting various rotary saws completely captivates the rotary saw in the x-, y-, and z-axes so that ones hands can be free to manipulate the work piece thereby achieving fine, detailed control of the cutting and shaping process. The rotary saw table and method for adapting various rotary saws comprises one assembly that includes a one-piece work support element 10, a one-piece, narrow work support element support side-piece 20, two required, a one-piece, wide work support element support side-piece 40, two required, a rotary saw 51, a rotary saw cutting bit 52, a rotary saw model adapter 53A or 53B or 53C or 53D or 53E or 53F or 53G or 53H, a rotary saw mount 54, a rotary saw mount vertical bracket 55, a rotary saw mount vertical bracket doubler 64 or 64A, a machine screw 68, two required, an optional part of assembly 50, a rotary saw mount side bracket 56, two required, a thumbscrew 57, six required, a clamp 58, four required, a machine screw 59, two required, a machine screw 60, two required, a machine screw 61, eight required, a locknut 62, ten required, a locknut 63, two required, a vacuum adapter base 65, a vacuum adapter cover 66, and a vacuum adapter hose fitting 67. Item 51 is a generic representation only and does not represent all of the possible rotary saws available that can be utilized. Item 52 is a generic representation only and does not represent all of the possible cutting bits available. Items 53A through 53H represent only a portion of all of the possible variations of adapters. Work support element 10, two work support element support, narrow side-piece 20, and two work support element support, wide side-piece 40, are sized to promote comfort with the operator in either a seated position or a standing position and to allow adequate work support element area so as to provide stable support for a plurality of work piece sizes. A preferred embodiment of work support element 10, two work support element support, narrow side-piece 20, and two work support element support, wide side-piece 40, includes a work support element height approximately equal to the height of a typical desk top, and a work support element work support element area that is larger than a typical scroll saw work support element area. With all pieces of the assembly in place the subject invention firmly captivates the rotary saw safely and securely in the x-, y-, and z-axes while allowing the rotary cutting bit to adequately extend above the plane of work support element 10. Vacuum adapter base 65 mounts in contact with work support element 10 and adjacent to rotary saw mount 54. Vacuum adapter cover 66 mounts in contact with vacuum adapter base 65 and in contact with rotary saw mount 54. Vacuum adapter hose fitting 67 mounts in contact with vacuum adapter cover 66. Alternative versions of the various items and assemblies are contained herein.

### BACKGROUND—CROSS-REFERENCE TO RELATED APPLICATIONS

This application is entitled t the benefit of Provisional Patent Application No. 60/540,017, filed Jan. 29, 2004.

### BACKGROUND

1. Field of Invention

This present invention relates to scroll saws, specifically to a method and an apparatus for adaptation of various hand-held rotary saws for use as scroll saws.

2. Discussion of Prior Art

Power-driven hand-held rotary saw tools are known to exist in prior art. Such tools currently available do not have cutting tables available as accessories and such tools currently available do not have a method of mounting to cutting table surfaces. Such a rotary saw cutting table and a method of mounting various rotary saws to such a rotary saw cutting table would significantly enhance the ability to perform detail work with various rotary saws.

Rotary saw tools rotate cutting bits up to very high RPM. They are useful for cutting holes in drywall, wall tile, and countertops, to name a few. Although such rotary tools are very useful in numerous applications they do have limitations. The typical work piece being cut is secured in place as part of a larger structure and the rotary saw is hand-held firmly by the operator while making the cuts freehand. This hand-held method is at best difficult when trying to perform detailed work on small work pieces. Holding the rotary saw in one's hands while trying to cut small work pieces or unclamped work pieces is extremely impractical and potentially dangerous. Some available hand-held rotary saw tools are too large and too heavy to hold properly for extreme detail work. Some available hand-held rotary tools that are smaller and lighter do not exhibit the higher torque required to cut heavier or thicker materials. When trying to perform detailed shaping or precise removal of material from a work piece with a hand-held rotating saw, the bit attachment can grab a material and cause a tool to be pulled in an unwanted direction thereby blemishing or even destroying a work piece.

Jigsaws are known to exist in prior art. The jig saw has a limitation in that it requires that the work piece be rotated as necessary to keep the desired cutting path aligned with the cutting blade. The size of the work piece that can be cut on a jigsaw is limited by the depth of the jigsaw support arm. The jigsaw is typically suited only for light-duty cutting of materials.

Scroll saws are known to exist in prior art. The scroll saw has a limitation in that it requires that the work piece be rotated as necessary to keep the desired cutting path aligned with the cutting blade. The size of the work piece that can be cut on a scroll saw is limited by the depth of the scroll saw support arm. Some scroll saw designs are known to claim unlimited throat depth, but since both ends of a blade have to be supported, a throat depth, however deep, imposes a size limit on the work piece. The scroll saw is typically suited only for light-duty cutting of materials.

A table mounting for power tool in U.S. Pat. No. 3,955,457 to Mendelson, is a fixture that relies on a partible household table for mounting. This could result in damage to a piece of household furniture. This allows for only straight cuts in material and excludes curved, free hand cuts.

A cutting tool jig with cutter guard in U.S. Pat. No. 4,206,672 to Smith, relates to a jig for a rotary table saw. This relates to different features as compared to the invention claimed in this application. Also, this allows for only straight cuts in material and excludes curved, free hand cuts.

A rotary cutter in U.S. Pat. No. 4,305,441 to Ohmi, relates to a type in which the rotary blade of a saw such as a table or radial saw or of a milling machine is mounted at an inclined angle and adapted to cut a groove of any desired width. This allows for only straight cuts in material and excludes curved, free hand cuts.

A cutting table in U.S. Pat. No. 4,877,069 to Plumley, relates to a portable table for use on land or on scaffolding that retains a circular saw. This allows for only straight cuts in material and excludes curved, free hand cuts.

A miter saw apparatus in U.S. Pat. No. 5,220,857 to Freeburger, relates to a rotary saw and a means of rotating it through various angles. This relates to different features as compared to the invention claimed in this application. Also, this allows for only straight cuts in material and excludes curved, free hand cuts.

A scroll saw in U.S. Pat. No. 5,303,627 to Shondel, relates to a scroll saw with an unlimited throat depth by using a wall mounted support arm for one end of a saw blade. Choosing a length for the wall mounted support arm limits the throat depth and limits the size of the work piece and limits the saw's portability.

A portable saw table in U.S. Pat. No. 5,421,231 to Break, et al., relates to table with a protractor and locking mechanism for making straight cuts at various angles. This allows for only straight cuts in material and excludes curved, free hand cuts.

A tool mounting means and implement therefore in U.S. Pat. No. 5,787,769 to Garuglieri, is designed around a circular saw blade thereby allowing only straight cuts. This allows for only straight cuts in material and excludes curved, free hand cuts.

A table saw assembly in U.S. Pat. No. 5,842,400 to McIntosh relates to a sliding table assembly for use with an ordinary circular saw. This allows for only straight angled cuts in material and excludes curved, free hand cuts.

A table saw in U.S. Pat. No. 5,857,507 to Puzio, et al., is for use with a table saw. This allows for only straight cuts in material and excludes curved, free hand cuts.

A portable saw table in U.S. Pat. No. 5,868,054 to Chubb, et al., is for use with a portable saw or router for cutting work pieces at varying angles. This allows for only straight cuts in material and excludes curved, free hand cuts.

A method and apparatus for connecting or securing a power tool with respect to a work support element in U.S. Pat. No. 5,884,681 to Nickles, requires that the apparatus be mounted to a work surface such as a tabletop or portable workbench. This requires that a separate work surface must be provided in order to make use of the apparatus which is a parallelogram frame.

A table saw top and mitre bar in U.S. Pat. No. 5,894,776 to Bartz, relates to a tabletop groove and mitre bar sized such that the mitre bar fits in the groove such that the top of the mitre bar does not extend above the plane of the tabletop. This relates to different features and applications as compared to the invention claimed in this application.

A table saw in U.S. Pat. No. 5,979,523 to Puzio, et al., relates to table saws and anti-kickback apparatuses, dust deflecting features, and machine carrying features. This allows for only straight cuts in material and excludes curved, free hand cuts.

A table saw in U.S. Pat. No. 6,009,782 to Tajima, et al., has a driven rotary blade and an air current means to blow wood chips out a discharge port. This relates to different features and applications as compared to the invention claimed in this application. Also, this allows for only straight cuts in material and excludes curved, free hand cuts.

A compact motorized table saw in U.S. Pat. No. 6,080,041 to Greenland, relates to a saw with a compact frame that can cut large work pieces and an automatic turn on feature. This relates to different features and applications as compared to the invention claimed in this application. Also, this allows for only straight cuts in material and excludes curved, free hand cuts.

A table saw in U.S. Pat. No. 6,131,629 to Puzio, et al., relates to table saws and anti-kickback apparatuses, dust deflecting features, and machine carrying features. This allows for only straight cuts in material and excludes curved, free hand cuts.

A power tool mounting stand in U.S. Pat. No. 6,209,597 to Calcote, relates to a positionable top for various power tools primarily capable of only straight cuts in material. This relates to different features and applications as compared to the invention claimed in this application.

A stone and tile table saw apparatus in U.S. Pat. No. 6,253,757 to Benson, includes a circular saw blade and a cooling liquid for the blade for cutting stone and tile. This relates to different features as compared to the invention claimed in this application. Also, this allows for only straight cuts in material and excludes curved, free hand cuts.

A power tool and portable support assembly in U.S. Pat. No. 6,360,797 to Brazell, et al., relates to power tools capable only of making straight cuts and another preferred embodiment illustrating a sanding drum. This relates to different features as compared to the invention claimed in this application. Also, this allows for only straight cuts in material and excludes curved, free hand cuts.

Router tables in U.S. Pat. No. 6,360,798 to Apolinski, pertains to fences used to guide work pieces during cutting with a router. This relates to different features as compared to the invention claimed in this application.

A tile saw in U.S. Pat. No. 6,427,677 to O'Banion, et al., relates to a saw with an increased cutting envelope for making straight cuts in tile. This relates to different features as compared to the invention claimed in this application. Also, this allows for only straight cuts in material and excludes curved, free hand cuts.

A portable tool support stand in U.S. Pat. No. 6,435,460 B1 to Van Cleave, et al., relates to a support stand for portable bending brakes. It includes a scissors-type stand, but it is intended for different applications and is more complex and has more individual parts as compared to the invention claimed in this application.

A portable table saw stand in U.S. Pat. No. 6,546,978 B2 to Thoman, relates to a two-part table saw stand system, the first part being a large folding table, the second part being a table saw carrier. This relates to different features as compared to the invention claimed in this application. Also, this allows for only straight cuts in material and excludes curved, free hand cuts.

No prior art directly germane to this invention was found which anticipates the inventive combination disclosed below. Furthermore, I am very familiar with both the hobby industry and the tool industry and have never seen anything promoted for sale like my rotary saw table and my method of adapting various rotary saws to my rotary saw table.

### SUMMARY

A rotary saw table and method for adapting various rotary saws to rotary saw table provides for greatly improved ease in detailed cutting of smaller work pieces in a multitude of applications. My rotary saw cutting table and method of adaptation of various hand-held rotary saws thereto allows for more delicate control of a desired operation. Securing a rotary saw to a rotary saw cutting table frees one's hands for controlling the work piece to be cut or shaped. By securely mounting a rotary saw to a rotary saw cutting table, safety of a user is enhanced, fine control over material shaping is enhanced, and the chance of damage to a small work piece is reduced. A preferred embodiment is described herein but in no way is intended to limit the design details of the subject invention. Applications include, but are not limited to, odd jobs, home repair jobs, arts and crafts including wall tile mosaics, hobby projects including model airplanes and model boats, and professional model building.

Objects and Advantages

Accordingly, several objects and advantages of my rotary saw table and method for adapting various rotary saws to rotary saw table are that it provides a power saw cutting table that allows for making cuts in material in any direction without having to rotate the material on the table about a cutting blade. The rotary saw table accepts various and numerous rotary saws available in the retail market. The rotary saw table allows for easy and secure mounting of a rotary saw below the plane of the cutting table, allowing the cutting bit to extend above the plane of the cutting table, thereby eliminating the need for any cutting blade support arm or other interfering or space-limiting mechanism above the plane of the cutting table. The x-y dimensions of the work piece are thereby not limited by the rotary saw table. Due to the secure mounting of a rotary saw to the rotary saw table, an operator's hands are free to control the work piece on the cutting table allowing for very precise detail work. It is capable of accepting a wide assortment of rotary saws. It converts popular rotary saw tools into even more versatile table saw tools. Examples of such rotary saw tools are the Rotozip Spiral Saw, manufactured by, and a registered trademark of, Roto Zip Tool Corporation of Cross Plains, Wis., the Dremel Advantage High-Speed Rotary Saw, manufactured by, and a registered trademark of, DREMEL of Racine, Wis. which is a division of Robert Bosch Tool Corporation, the Black & Decker Rotary Saw, manufactured by, and a registered trademark of, Black & Decker Corporation of Towson, Md., the DeWalt Rotary Saw, manufactured by, and a registered trademark of, Black & Decker Corporation of Towson, Md., the Bosch Spiracut Rotary Cutter, manufactured by, and a registered trademark of, Robert Bosch Tool Corporation which is a division of Robert Bosch GmbH of Stuttgart, Germany, the Ryobi Speed Saw, manufactured by, and a registered trademark of, Ryobi Technologies, Inc. of Anderson, S.C., and the Sears Craftsman All-In-One Cutting Tool, manufactured by, and a registered trademark of, Sears, Roebuck and Company of Hoffman Estates, Ill., all of which are accommodated by the preferred embodiment. For applications where not as much torque is required, my rotary saw table and method for adapting various rotary saws will also accommodate tools such as the Dremel Multi-Pro Rotary Tool, manufactured by, and a registered trademark of, DREMEL of Racine, Wis. which is a division of Robert Bosch Tool Corporation, and the Black & Decker RTX High Performance Rotary Tool, manufactured by, and a registered trademark of, Black & Decker Corporation of Towson, Md. My rotary saw table and method for adapting various rotary saws can be altered to conform to other rotary saw tools that employ a rotary cutting bit. Installation of a rotary saw tool onto my rotary saw table is quick and easy. No assembly tools are required to securely mount any of a plurality of rotary saw tools to my rotary saw table. It is very user-friendly and allows a user to make quick changes in cutting bits.

Scroll saws have a limitation in that the length of a cut cannot exceed the depth of the throat, or blade support arm. Unlike scroll saws that have such a cutting depth limitation, my rotary saw table and method for adapting various rotary saws to rotary saw table does not put any constraints on the length of a particular cut in a work piece.

My rotary saw table and method for adapting various rotary saws to rotary saw table is comprising of a minimum of pieces. The aforementioned pieces are fixed in position in relationship to each other prior to operation and do not move during operation. Accordingly, my rotary saw table and method for adapting various rotary saws to rotary saw table is very reliable.

My rotary saw table and method for adapting various rotary saws to rotary saw table accepts allows for work pieces made out of any material that can normally be cut by the particular rotary saw and bit combination installed. It provides the additional advantage of being able to cut much smaller work pieces than could normally be cut with a hand-held rotary saw and bit combination because both of the operator's hands are free to guide the work piece on the cutting table. It provides the additional advantage of being able to manipulate the work piece with both hands, thereby allowing for more precise, detailed cutting and shaping.

Other objects and advantages are illustrated as follows. Beautiful tile mosaics are very popular around the world. However, when making mosaics, one has to cut or break small pieces of colored tile with special pliers, or snips. This results in pieces of tile with rough, poorly defined edges that are then used to make a larger picture or scene. To create the illusion of a curve, one has to make a series of breaks or snips at various angles. The irregularly shaped pieces are small enough in relation to the overall scene so as to result in a scene with curved lines where necessary. My rotary saw table and method for adapting various rotary saws to rotary saw table will enable the operator, either professional or hobbyist, to cut detailed parts out of colored wall tile using smooth, curved cuts resulting in an infinite number of shapes in the exact shape desired. This eliminates the rough, poorly defined edges and results in very flowing, artistic patterns, more like a painting. This process cannot be achieved with a hand-held rotary saw, but my rotary saw table and method for adapting various rotary saws to rotary saw table will allow this process to be achieved. This opens up a new, improved way of making beautiful, gracefully detailed mosaics.

Cutting wood with a band saw and even a scroll saw requires that the work piece be rotated on the table surface such that the leading edge of a curved cut being made is always in the plane of the cutting blade. The work piece has to be constantly manipulated to orient it properly. My rotary saw table and method for adapting various rotary saws to rotary saw table allows the same cuts to be made without having to rotate the work piece. The work piece can remain in a firm, unchanging grip by the operator and, instead of rotating the work piece, it can simply be moved left or right, or fore and aft, as required, to achieve the same end results.

Variations of my rotary saw table and method for adapting various rotary saws will allow for adaptation of numerous rotary saws from a variety of different manufacturers. Variations in bit design by a variety of different manufacturers will allow for cutting of various materials using my rotary saw table.

A vacuum adapter assembly clears woodcuttings and abrasive tile cuttings away from the work piece and rotary saw and helps to prevent their entry into the cool air inlet of the rotary saw.

Further objects and advantages of my rotary saw table and method for adapting various rotary saws will become apparent from a consideration of the drawings and ensuing description.

### DRAWING FIGURES

Description of Drawings

FIG. 1 shows a perspective view and cutaway of rotary saw table with a generic representation of a rotary saw

FIG. 2 shows an exploded view of rotary saw table and rotary saw mounting assembly with a generic rotary saw

FIG. 3 shows a perspective view of a rotary saw mounting assembly with a generic representation of a rotary saw

FIG. 4 shows an exploded view of a mounting assembly

FIG. 5 shows an exploded view of a generic rotary saw and a mounting adapter

FIG. 6 shows some examples of rotary saw mounting adapters

FIG. 7 shows a perspective of a rotary saw mount vertical bracket with optional doubler

FIG. 8 shows a perspective of a vacuum adapter assembly

FIG. 9 shows a perspective of a rotary saw mount vertical bracket with optional alternative embodiment doubler

FIG. 10A shows a perspective of an optional alternative embodiment means of support using four short legs

FIG. 10B shows a perspective of an optional alternative embodiment means of support using four long legs

FIG. 10C shows a perspective of an optional alternative embodiment means of support using a generic metal tool stand

FIG. 10D shows a perspective of an optional alternative embodiment means of support using adapters for folding clamp tables

FIG. 10E shows a perspective of an optional alternative embodiment means of support using clampable supports

FIG. 10F shows a perspective of an optional alternative embodiment means of support using flush mounting

Reference Numerals in Drawings

| | |
|---|---|
| 10 | work support element |
| 20 | work support element support, narrow side-piece |
| 40 | work support element support, wide side-piece |
| 50 | rotary saw mounting assembly with generic representation of |
| | rotary saw |
| 51 | rotary saw |
| 52 | rotary saw cutting bit |
| 53A | rotary saw model adapter, Dremel Multi-Pro |
| 53B | rotary saw model adapter, Black & Decker RTX |
| 53C | rotary saw model adapter, Rotozip |
| 53D | rotary saw model adapter, Dremel Advantage |
| 53E | rotary saw model adapter, Black & Decker Rotary Saw |
| 53F | rotary saw model adapter, Sears Rotary Saw |
| 53G | rotary saw model adapter, Ryobi Rotary Saw |
| 53H | rotary saw model adapter, DeWalt Rotary Saw |
| 54 | rotary saw mount |
| 55 | rotary saw mount, vertical bracket |
| 56 | rotary saw mount, side bracket |
| 57 | thumbscrew |
| 58 | bracket |
| 59 | machine screw |
| 60 | machine screw |
| 61 | machine screw |
| 62 | lock nut |
| 63 | lock nut |
| 64 | doubler, rotary saw mount vertical bracket |
| 64A | doubler, alternative embodiment, rotary saw vertical bracket |
| 65 | vacuum adapter base |
| 66 | vacuum adapter cover |
| 67 | vacuum adapter hose fitting |
| 68 | machine screw |
| 69 | work support element support, short legs, alternative embodiment |
| 70 | work support element support, long legs, alternative embodiment |
| 71 | work support element support, generic metal tool stand, alternative |
| | embodiment |
| 72 | work support element support, clamp table adapters, alternative |
| | embodiment |
| 73 | work support element support, clampable supports, alternative |
| | embodiment |

### DESCRIPTION OF INVENTION—PREFERRED EMBODIMENT

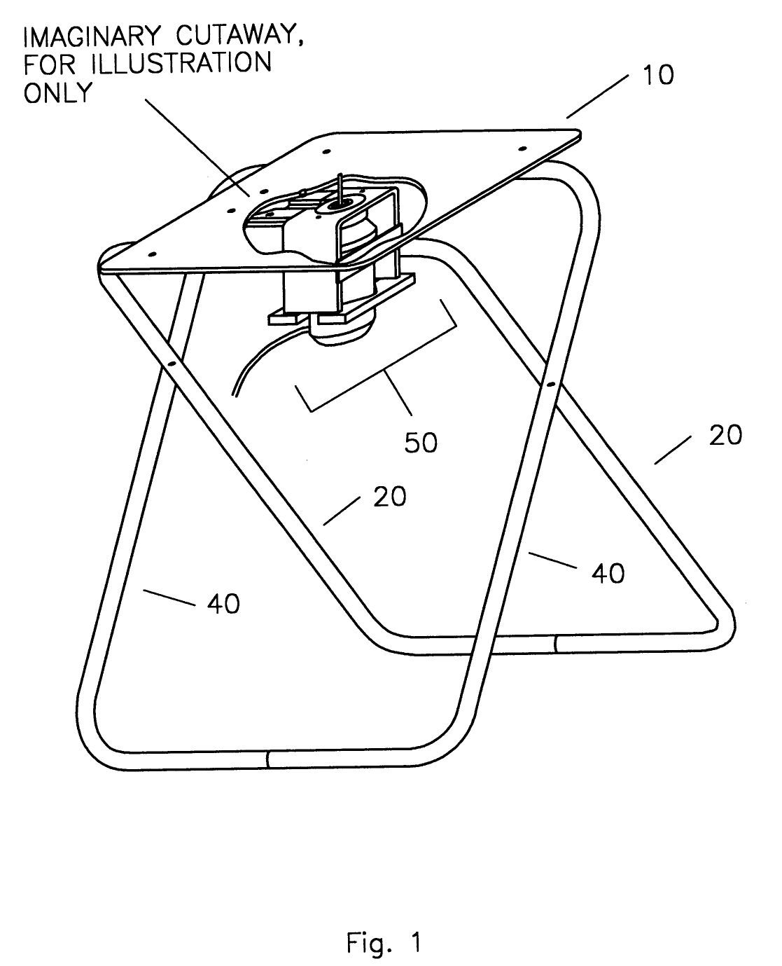

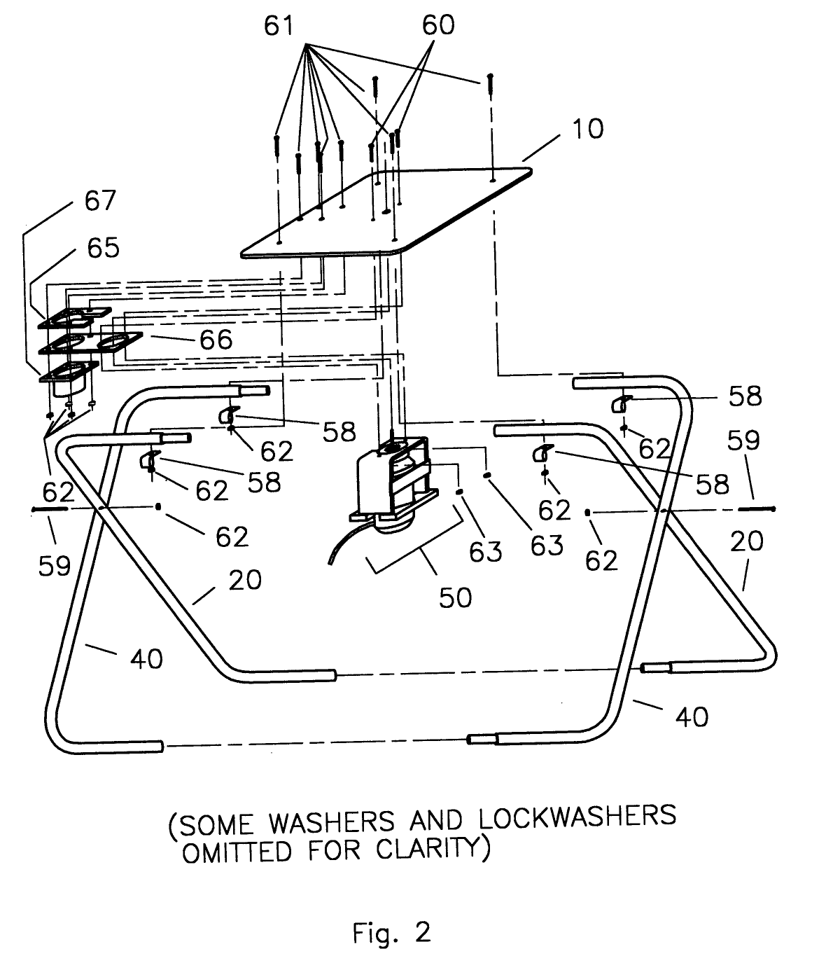

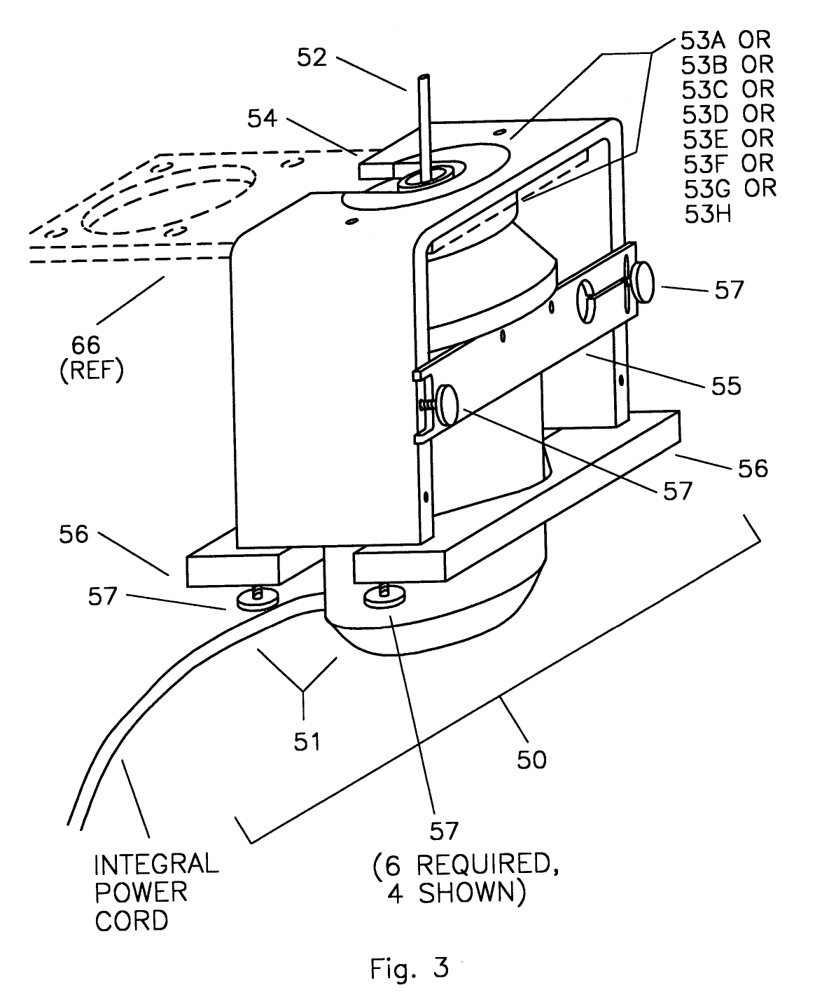

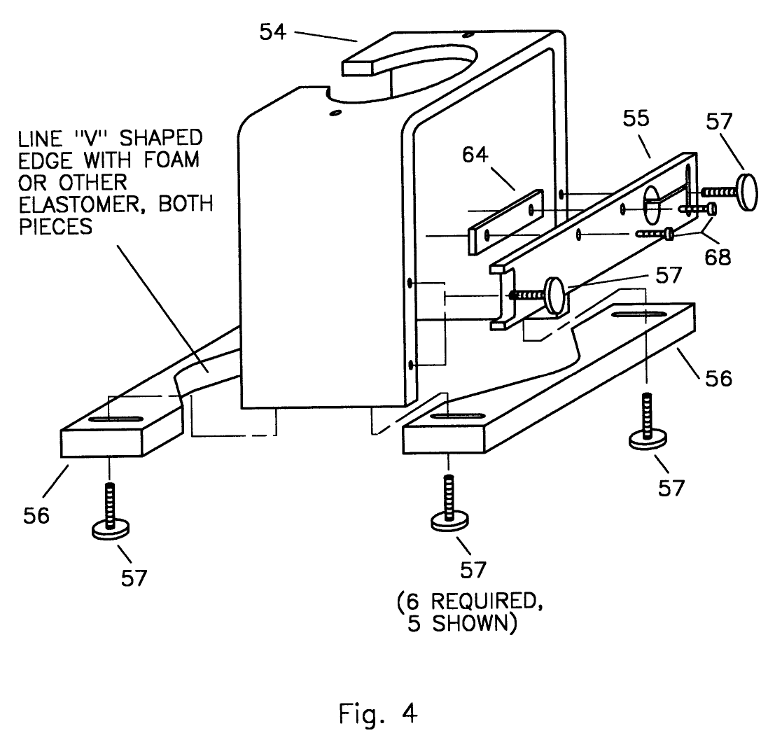

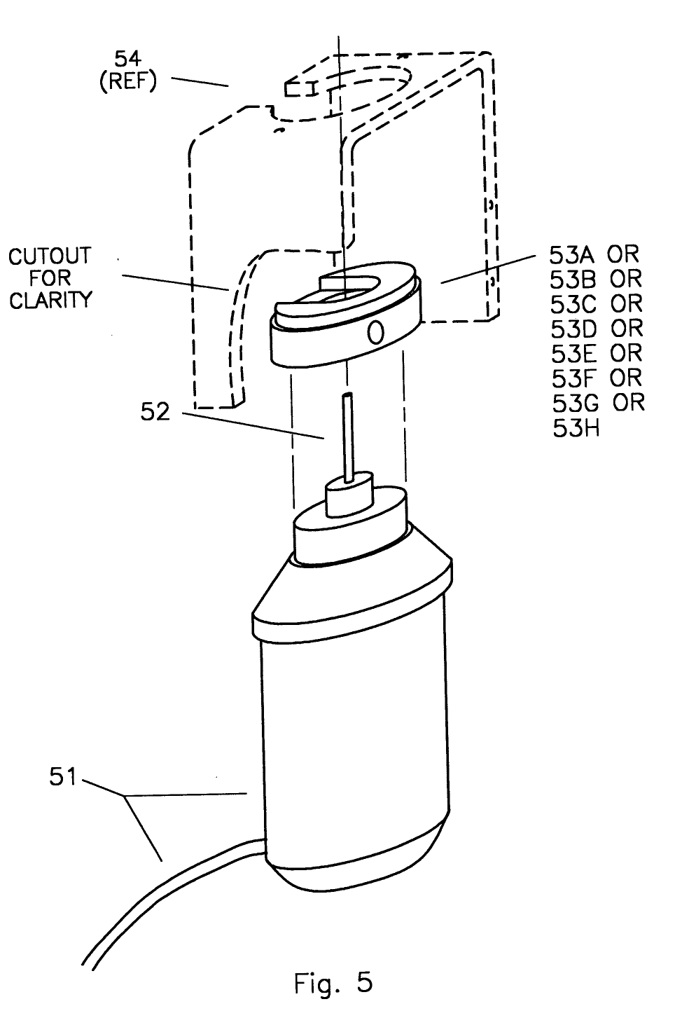

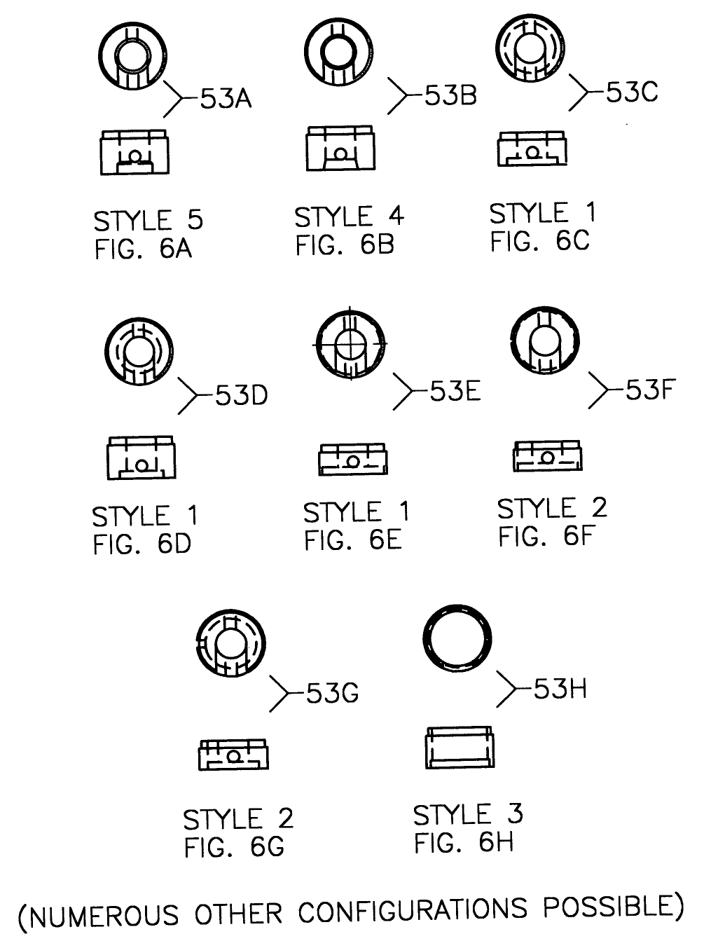

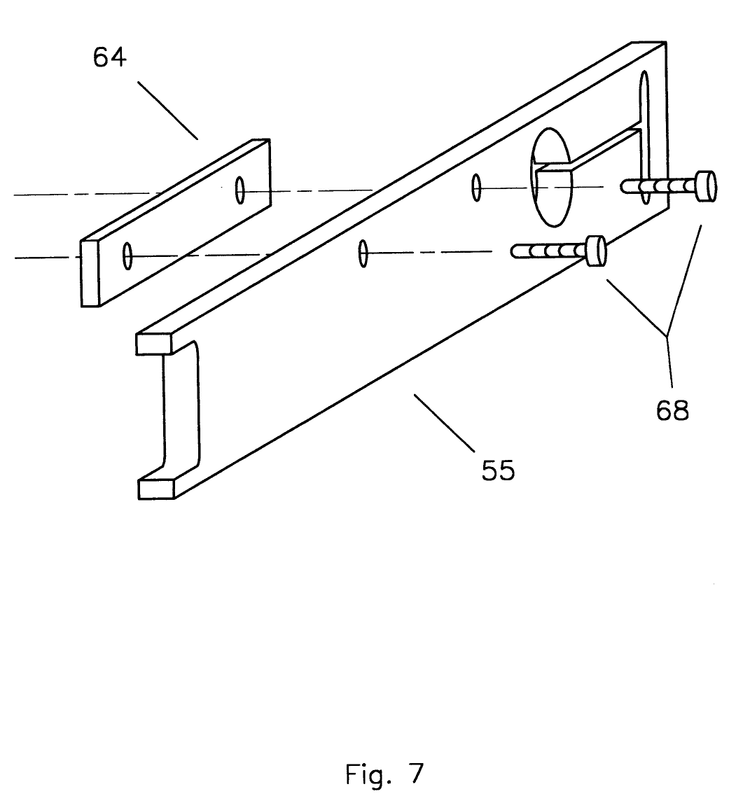

A rotary saw table and method for adapting various rotary saws of the subject invention provides for greatly improved ease in cutting, sawing, and sanding in a multitude of applications. A preferred embodiment is described herein but in no way is intended to limit design details, size, materials, finish, or methods of manufacturing, of the subject invention. FIG. 1 shows a perspective of the preferred embodiment. FIG. 2 shows an exploded view perspective of the rotary saw table and rotary saw mounting assembly with a generic rotary saw. FIG. 3 shows a perspective of the rotary saw mounting assembly including a generic rotary saw and the rotary saw mount. FIG. 4 shows an exploded view perspective of the rotary saw mount. FIG. 5 shows an exploded view perspective of a generic rotary saw, rotary saw cutting bit, and rotary saw model adapter. FIG. 6 shows some examples of rotary saw mounting adapters. FIG. 7 shows an exploded view perspective of the rotary saw mount vertical bracket and an optional doubler. FIG. 8 shows an exploded view perspective of the vacuum adapter assembly. My rotary saw table and method for adapting various rotary saws comprises one assembly that includes a one-piece work support element 10, FIG. 1 and FIG. 2, a one-piece, narrow work support element support side-piece 20, two required, FIG. 1 and FIG. 2, a one-piece, wide work support element support side-piece 40, two required, FIG. 1 and FIG. 2, a rotary saw mounting assembly with generic representation of rotary saw 50, FIG. 1, FIG. 2, and FIG. 3, a rotary saw 51, part of assembly 50, FIG. 3, and FIG. 5, a rotary saw cutting bit 52, part of assembly 50, FIG. 3, and FIG. 5, a rotary saw model adapter 53A or 53B or 53C or 53D or 53E or 53F or 53G or 53H, part of assembly 50, FIG. 3, FIG. 5, and FIG. 6A through FIG. 6H, respectively, a rotary saw mount 54, part of assembly 50, FIG. 3, FIG. 4, and FIG. 5, a rotary saw mount vertical bracket 55, part of assembly 50, FIG. 3, FIG. 4, and FIG. 7, a rotary saw mount vertical bracket doubler 64, an optional part of assembly 50, FIG. 4 and FIG. 7, a machine screw 68, two required, an optional part of assembly 50, FIG. 4 and FIG. 7, a rotary saw mount side bracket 56, two required, part of assembly 50, FIG. 3, and FIG. 4, a thumbscrew 57, six required, part of assembly 50, FIG. 3, and FIG. 4, a clamp 58, four required, FIG. 2, a machine screw 59, two required, FIG. 2, a machine screw 60, two required, FIG. 2, a machine screw 61, eight required, FIG. 2, a locknut 62, ten required, FIG. 2, a locknut 63, two required, FIG. 2, a vacuum adapter base 65, FIG. 2 and FIG. 8, a vacuum adapter cover 66, FIG. 2 and FIG. 8, and a vacuum adapter hose fitting 67, FIG. 2 and FIG. 8. Item 51 is a generic representation only and does not represent all of the possible rotary saws available that can be utilized. Item 52 is a generic representation only and does not represent all of the possible cutting bits available. Items 53A through 53H represent only a portion of all of the possible variations of adapters. Work support element 10, two work support element support, narrow side-piece 20, and two work support element support, wide side-piece 40 are made to mate together in their proper, respective positions relative to each other. Work support element 10, two work support element support, narrow side-piece 20, and two work support element support, wide side-piece 40, are sized to promote comfort with the operator in either a seated position or a standing position and to allow adequate work support element area so as to provide stable support for a plurality of work piece sizes. A preferred embodiment of work support element 10, two work support element support, narrow side-piece 20, and two work support element support, wide side-piece 40, includes a work support element height approximately equal to the height of a typical desk top, and a work support element area that is larger than a typical scroll saw work support element area. Rotary saw mount 54 is sized to allow the mounting of a plurality of rotary saws 51 as illustrated in FIG. 1, FIG. 2, FIG. 3, and FIG. 5. The rotary saw mount 54 is made to mate together with work support element 10 in their proper, respective positions relative to each other. Two each of rotary saw mount side bracket 56 are made to slideably mate under and between the two sides of rotary saw mount 54 using four each of thumbscrew 57 as shown in FIG. 4. As shown in FIG. 4, the “V” shaped edge of rotary saw mount side bracket 56 is lined with a compressible material, such as foam or other elastomer. Another two each of thumbscrew 57 are made to mate together with the two sides of rotary saw mount 54 in their proper, respective positions relative to each other as shown in FIG. 4. Rotary saw 51 is made to mate together with a style of rotary saw cutting bit 52 that is best suited for the material to be cut and one of rotary saw model adapter 53A or 53B or 53C or 53D or 53E or 53F or 53G or 53H or another variation in their proper, respective positions relative to each other. Rotary saw mount vertical bracket 55 is installed either before or after installing rotary saw 51 depending on the style of rotary saw 51. Some styles of rotary saw 51 have an integral handle that cannot be removed prior to installation in my rotary saw table assembly. For those styles of rotary saw 51, rotary saw mount vertical bracket 55 will have to be installed through or under the handle after rotary saw 51 has been placed in its approximate final position. For other styles of rotary saw 51 without handles or with handles that can be removed, rotary saw mount vertical bracket 55 can be loosely installed prior to installation of rotary saw 51. When appropriate, based on the style of rotary saw 51, rotary saw mount vertical bracket 55 is made to mate across and between the two sides of rotary saw mount 54 by slipping over the two previously installed thumbscrew 57 as shown in FIG. 4. In a preferred embodiment one end of the appropriate rotary saw model adapter 53A or 53B or 53C or 53D or 53E or 53F or 53G or 53H or another variation fits snugly over the bit holding end of rotary saw 51 and the other end of the same rotary saw model adapter fits snugly inside the large diameter orifice in rotary saw mount 54 such that the bit holding end of rotary saw 51 and rotary saw cutting bit 52 are held securely in place in regards to both the x-axis and the y-axis. In a preferred embodiment a loosely installed rotary saw mount vertical bracket 55 is pushed up against a portion of the body of rotary saw 51, which portion could be, for example, a larger-diameter portion of the body or its handle that extends over the edge of rotary saw mount vertical bracket 55, such that rotary saw model adapter 53A or 53B or 53C or 53D or 53E or 53F or 53G or 53H or another variation is fully seated within the larger diameter orifice of rotary saw mount 54. While same is fully seated as described above, two thumbscrew 57 are tightened against rotary saw mount vertical bracket 55 thereby securing rotary saw mount vertical bracket 55 in place and thereby securing rotary saw 51 in place and thereby capturing rotary saw model adapter 53A or 53B or 53C or 53D or 53E or 53F or 53G or 53H or another variation between rotary saw 51 and rotary saw mount 54 such that the bit holding end of rotary saw 51 and rotary saw cutting bit 52 are held securely in place in the z-axis. In a preferred embodiment two each of loosely installed rotary saw mount side bracket 56 are squeezed against a lower portion of the body of rotary saw 51 such that the foam or other elastomer in the “V” shaped edge of bracket 56 is compressed against the body of rotary saw 51. Both of bracket 56 along with rotary saw 51, while being squeezed together, are moved from side to side as necessary to bring rotary saw 51 and its installed rotary saw cutting bit 52 to a position parallel to the z-axis at which time four thumbscrew 57 are tightened against each rotary saw mount side bracket 56 thereby securing each rotary saw mount side bracket 56 in position against each side of rotary saw mount 54 such that the lower portion of rotary saw 51 is held securely in place in both the x-axis and the y-axis. With all pieces of the assembly in place the subject invention firmly captivates the rotary saw safely and securely in the x-, y-, and z-axes while allowing the rotary cutting bit to adequately extend above the plane of work support element 10. Vacuum adapter base 65 mounts in contact with work support element 10 and adjacent to rotary saw mount 54 as illustrated in FIG. 2. Vacuum adapter cover 66 mounts in contact with vacuum adapter base 65 and in contact with rotary saw mount 54 as illustrated in FIG. 2 and FIG. 3. Vacuum adapter hose fitting 67 mounts in contact with vacuum adapter cover 66 as illustrated in FIG. 2 and FIG. 8.

### OPERATION OF INVENTION

The description contained herein is based on the preferred embodiment and assumes that no pieces of the assembly have previously been connected to each other. To prepare the rotary saw table use it must first be assembled. Thereafter it can be left assembled. Referring to FIG. 2, one first slides together two work support element support, narrow sidepiece 20 by sliding the swaged end of one into the non-swaged end of the other. Next, one slides together two work support element support, wide side-piece 40 by sliding the swaged end of one into the non-swaged end of the other. The two resulting work support element support assemblies are laid on a flat surface for further assembly wherein the narrow work support element support assembly is laid inside the wide work support element support assembly. The screw holes, which could also be referred to more generally as mounting points, on the long sides of each assembly are aligned with each other such that a machine screw 59 can be placed through the holes of each of the two supports. Although not shown in FIG. 2 because it is non-essential, a plastic-like washer can be inserted over each machine screw 59 and between the wide and narrow support assemblies to help prevent the support assemblies from rubbing against each other. Each machine screw 59 is mated with a lock nut 62 after each machine screw 59 has been pushed through both of the support assemblies. At this stage of assembly machine screw 59 and lock nut 62 are not to be tightened together but instead are to be left somewhat loose. Next, work support element 10 is mated to the work support element support assembly by rotating the wide and narrow work support element supports apart and installing four bracket 58 onto work support element supports as illustrated in FIG. 2 such that each screw hole in each bracket 58 lines up with the four corresponding screw holes in work support element 10. Four machine screw 61 are then inserted first through the four corresponding holes in work support element 10 and then through the corresponding screw holes of the four brackets, 58, as shown in FIG. 2. Since the work support element support assembly is still loosely assembled at this point, the parts of the work support element support assembly can be moved around somewhat, as necessary, to align the screw holes properly. Then four machine screw 61 are mated with four lock nut 62 and tightened together. Each machine screw 59 and lock nut 62 can at this stage be further tightened until snug. Referring to FIG. 4, note that the two sides of rotary saw mount 54 each have two threaded screw holes along one edge for accepting one thumbscrew 57 for each side of rotary saw mount 54 wherein the two thumbscrew 57 are used to hold on rotary saw mount vertical bracket 55. Referring to FIG. 2 and FIG. 3, next mount the rotary saw mount 54 to the underside of work support element 10 while at the same time mounting vacuum adapter cover 66 to the underside of rotary saw mount 54 using two machine screw 60 and two lock nut 63. Referring to FIG. 2 and FIG. 8, mount vacuum adapter base 65 between work support element 10 and vacuum adapter cover 66 and mount vacuum adapter hose fitting 67 to the underside of vacuum adapter cover 66 using four machine screw 61 and four lock nut 62. When in their proper respective positions, the horizontal slot voids of vacuum adapter base 65 and rotary saw mount 54 should butt together and line up with each other. Referring to FIG. 4 and the two each holes in the edge of each side of rotary saw mount 54, mate two each thumbscrew 57 to either the hole nearest to the position of rotary saw mount side bracket 56 (hereafter referred to as the bottom hole) or to the other hole (hereafter referred to as the top hole). Selecting whether to use the bottom hole or the top hole is determined by the model and/or manufacturer of rotary saw 51 used. The Ryobi and Sears models of rotary saw 51 require mating of two each thumbscrew 57 to the bottom holes. All other known brands require mating of two each thumbscrew 57 to the top holes. Referring to FIG. 4, next loosely mate one rotary saw mount side bracket 56 (hereafter referred to as the first bracket 56) across the ends of and between the two sides of rotary saw mount 54 on the side of rotary saw mount 54 opposite to the aforementioned top holes and bottom holes by inserting two each thumbscrew 57 through each respective slot in the first bracket 56 and then mating each thumbscrew 57 to their respective threaded hole in the end of rotary saw mount 54. When properly mated to each side of rotary saw mount 54, the “V” shaped edge of each bracket 56 will face each other and will be in apposition to each other as shown in FIG. 4. The other rotary saw mount side bracket 56 (hereafter referred to as the second bracket 56) is loosely mated using the same procedure, but the second bracket 56 may have to be mounted after inserting rotary saw 51 into position, as determined by the model and/or manufacturer of rotary saw 51. Specifically, the second bracket 56 will have to be mounted after inserting rotary saw 51 if rotary saw 51 is made by either Black & Decker or Dremel due to the presence on each of a non-removable rotary saw handle. For other known rotary saw 51 manufacturers, the second bracket 56 can be loosely mated immediately after the first bracket 56 using the same procedure. Next, a rotary saw cutting bit 52, of a style appropriate for the material to be cut, is mated to a rotary saw 51 using instructions provided by the manufacturer of rotary saw 51. Next, referring to FIG. 5, rotary saw model adapter 53A or 53B or 53C or 53D or 53E or 53F or 53G or 53H or another variation, selected based on the style and manufacturer of rotary saw 51, is mated to rotary saw 51 by slipping the adapter over the end of rotary saw 51 and seating it on the end of rotary saw 51. Referring to FIG. 3 and FIG. 5, next mate the assembly that includes rotary saw 51, rotary saw cutting bit 52, and rotary saw model adapter 53A or 53B or 53C or 53D or 53E or 53F or 53G or 53H or another variation, with the rotary saw mount such that the rotary saw model adapter 53A or 53B or 53C or 53D or 53E or 53F or 53G or 53H or another variation is fully seated into the large-diameter hole in rotary saw mount 54 such that slot in rotary saw model adapter 53A or 53B or 53C or 53D or 53E or 53F or 53G or 53H or another variation is lined up with the slot void in rotary saw mount 54. This last step referenced above may be easier to perform if the assembly that comprises work support element 10, two work support element support 20, and two work support element support 40 are laid over horizontally such that the assembly that includes rotary saw 51, rotary saw cutting bit 52, and rotary saw model adapter 53A or 53B or 53C or 53D or 53E or 53F or 53G or 53H or another variation can be supported against gravity by rotary saw mount 54 and the first bracket 56. Next, install second bracket 56, if not already installed. Referring to FIG. 4 and FIG. 7, next install rotary saw mount vertical bracket 55 (hereafter referred to as bracket 55) by first aligning the large, circular hole in bracket 55 over thumbscrew 57, previously installed in either the top hole or bottom hole on the edge of rotary saw mount 54, such that bracket 55 can be lowered over thumbscrew 57. Move bracket 55 to engage the threaded shaft of thumbscrew 57 in the horizontal slot on the side of the large, circular hole and then further move bracket 55 along the horizontal slot until the threaded shaft of thumbscrew 57 is in the vertical slot of bracket 55. At this point the other end of bracket 55, with its open face vertical slot, will come into contact with the threaded shaft of the other thumbscrew 57. Depending on the style of rotary saw 51 used, it may be necessary to install rotary saw mount vertical bracket doubler 64 (hereafter referred to as doubler 64) onto bracket 55 using two machine screw 68 in accordance with FIG. 7. Next, slide bracket 55 in a direction towards work support element 10 such that bracket 55, or the combination of bracket 55 and doubler 64, engages the underside of the handle, or a large-diameter portion of the body, of rotary saw 51, as appropriate dependent on the style and manufacturer of rotary saw 51, such that bracket 55 and the assembly including rotary saw 51 are unable to slide any further. Next, firmly tighten both thumbscrew 57 on each end of bracket 55 such that bracket 55 is firmly and securely held in position against the edges of, and between, the two sides of rotary saw mount 54. This will firmly secure and immobilize the assembly that includes rotary saw 51 along the z-axis. Next, loosely install the second bracket 56 in accordance with the previously described procedure, if it hasn't already been loosely installed. Next, the entire assembly can be made to stand upright again. Next, firmly squeeze both the first bracket 56 and the second bracket 56 against the sides of rotary saw 51 such that the foam or other elastomer in the “V” shaped edge of each bracket 56 is compressed against the body of rotary saw 51 and move the assembly that includes the first bracket 56, the second bracket 56, and rotary saw 51 back and forth until rotary saw cutting bit 52 is approximately perpendicular to work support element 10. Next, while firmly squeezing, tighten the four remaining thumbscrew 57 such that the first bracket 56 and the second bracket 56 are firmly and securely held in position in relation to each side of rotary saw mount 54. This completes the assembly and installation process. A vacuum hose can now be attached to vacuum adapter hose fitting 67. My invention is now ready to use.

There should be no need to disassemble the rotary saw table. However, if one desires to remove the rotary saw for other uses, it is only necessary to loosen any appropriate thumbscrew 57, thereby loosening the appropriate rotary saw mount side bracket 56 and/or rotary saw mount vertical bracket 55. Once the rotary saw has been removed, the rotary saw model adapter 53A or 53B or 53C or 53D or 53E or 53F or 53G or 53H or another variation can easily be removed from the rotary saw.

The rotary saw table can be folded for easier storage by removing two bracket 58 from one side of the assembly and loosening the other two bracket 58. The work support element assembly can then be rotated down and the free work support element support can be rotated in for compact storage.

The “V” shaped side of rotary saw mount side bracket 56 is lined with a compressible material, such as foam or other elastomer, that is compressed against the sides of rotary saw 51 to aid in safely and securely holding rotary saw 51 is in its final “x” and “y” axis position. Rotary saw mount vertical bracket 55 is used to safely and securely hold rotary saw 51 in its final “z” axis position.

When all parts are assembled and fixed in their respective positions relative to each other, vacuum adapter cover 66 in concert with the slot voids in rotary saw mount 54, vacuum adapter base 65, and rotary saw model adapter 53A or 53B or 53C or 53D or 53E or 53F or 53G or 53H or another variation form a plenum such that a vacuum, attached by way of a vacuum hose to vacuum adapter hose fitting 67, can pull air and cuttings down through the center hole of work support element 10 and up through the side holes of rotary saw model adapter 53A or 53B or 53C or 53D or 53E or 53F or 53G or 53H or another variation.

### Description and Operation of Alternative Embodiments

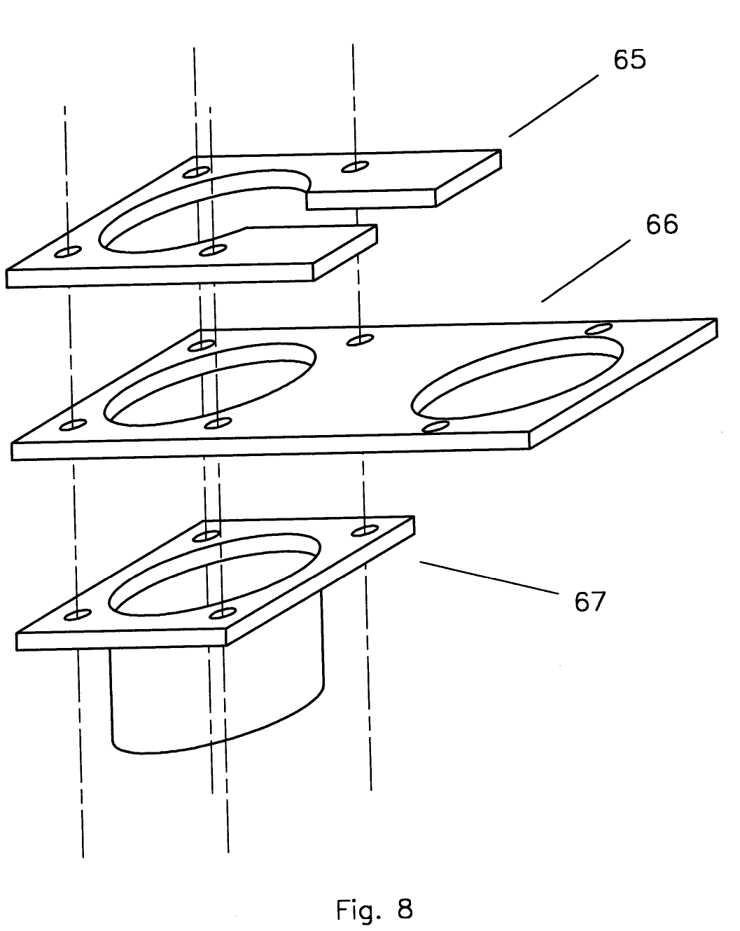

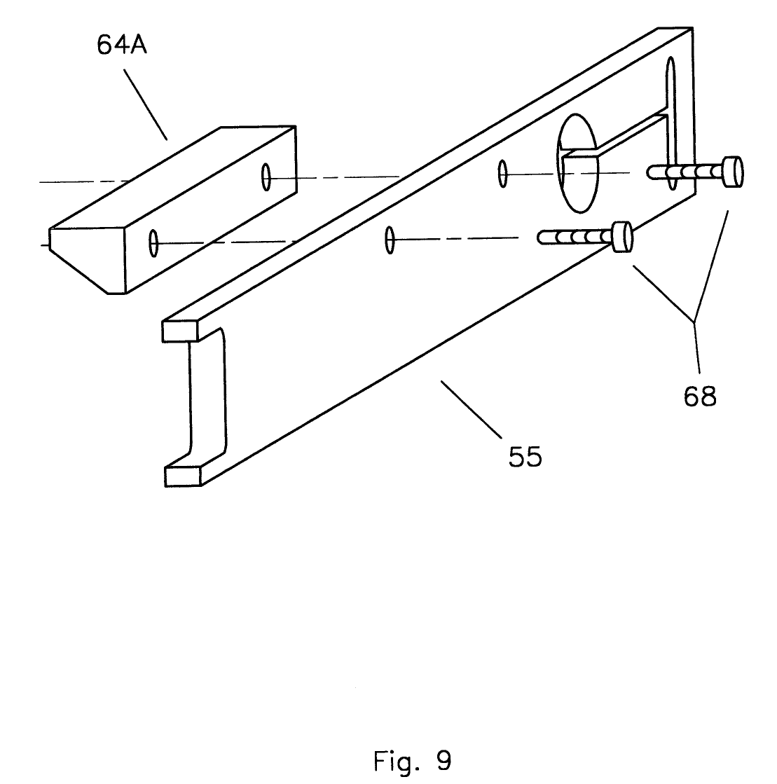

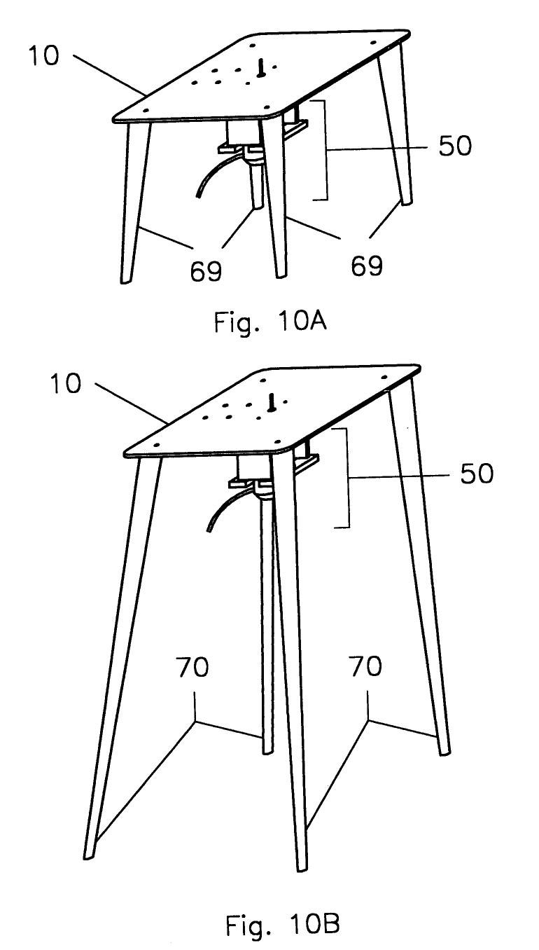

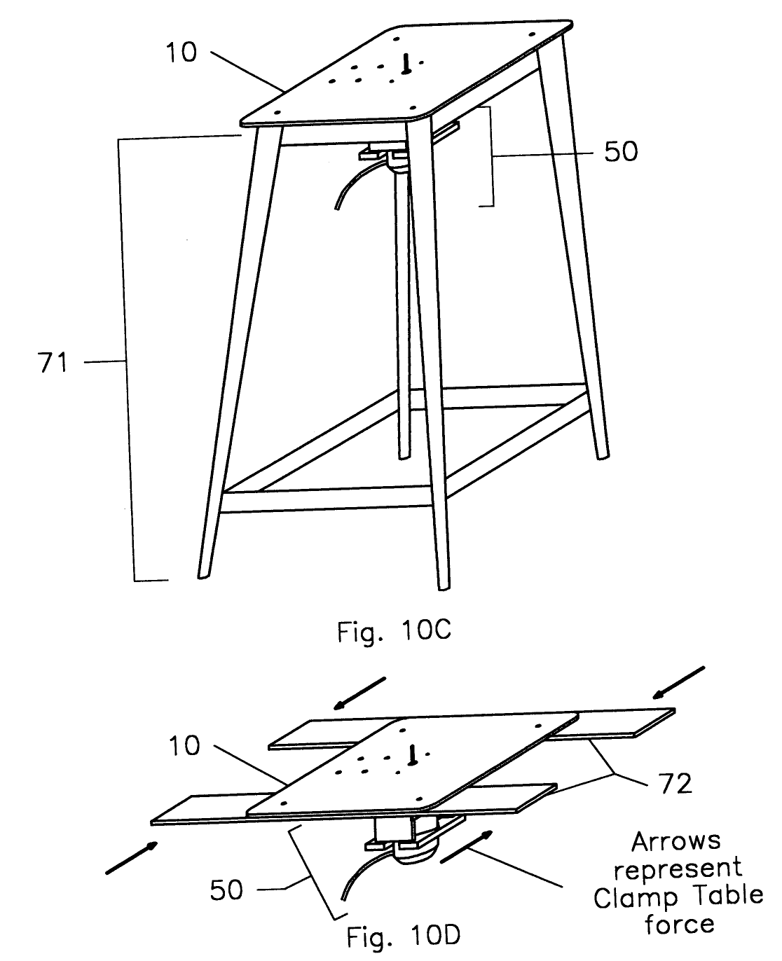

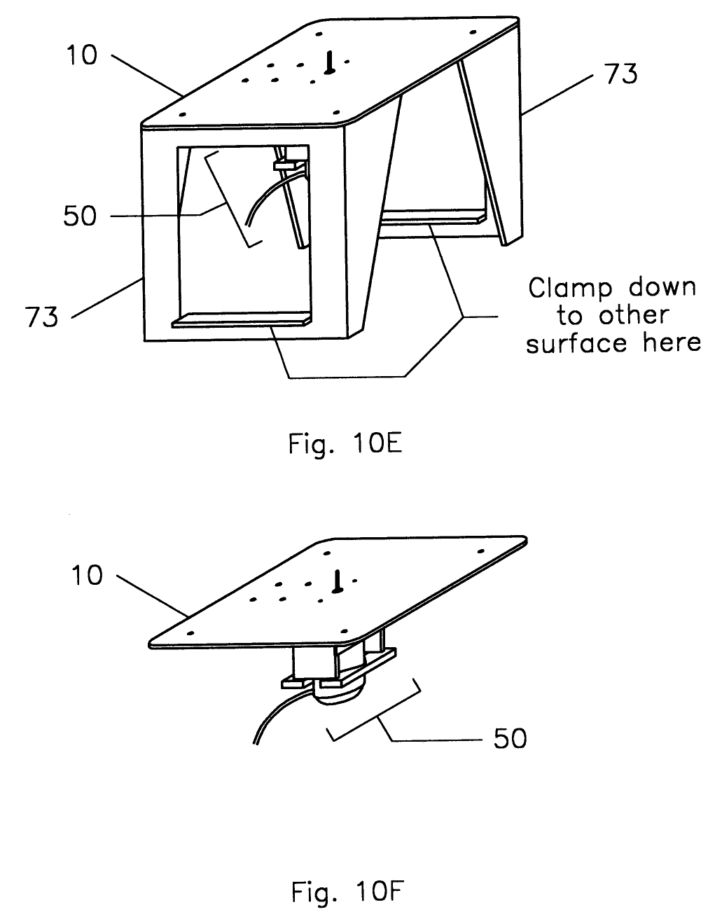

There are numerous possibilities with regard to a method of manufacture, size, shape, material, and application. Methods of manufacture can include, but are not limited to, laser-cutting, machining, molding, casting, molding with secondary machining, casting with secondary machining, and metal injection molding. Methods of attaching various pieces to each other can vary to accommodate various assembly techniques. When using screws to attach various pieces to each other the screws can be secured in place using lock washers or liquid thread lock or other means to accommodate various assembly techniques. At appropriate mounting points used for joining one or more pieces together, the screws could be replaced with threaded studs. The rotary saw vertical bracket, reference numeral 55, can be made from a plastic or polymer material, from aluminum, from laser-cut ply or other material as appropriate. The optional rotary saw vertical bracket doubler, reference numeral 64, can be made from a plastic or polymer material, from aluminum, from laser-cut ply or other material as appropriate, and the doubler can be made from different thicknesses of sheet stock material or it can be made in a more complex form from block material as illustrated in an alternative embodiment, reference numeral 64A, FIG. 9. The alternative embodiment doubler, reference numeral 64A, would be more appropriate for narrow body rotary tools. The rotary saw model adapter, reference numeral 53A through 53H and other versions, can be made from a plastic or polymer material, or from aluminum, or from ply or laminate, or any other material as deemed appropriate. The rotary saw model adapter can be made either as a one-piece adapter via molding or CNC machining or other suitable process, or it can be made as a stack using multiple layers of laser-cut material thereby avoiding higher costs typically associated with molding or CNC machining. The ON/OFF finger switch, provided with each rotary saw 51, could be supplemented with an ON/OFF foot switch. The rotary saw mount, reference numeral 54, could be made as two separate vertical sidewalls without the adjoining horizontal sidewall and attached to the underside of the work support element, reference numeral 10, using brackets or other suitable means. For some of the softer construction materials, such as some plastics, ply woods, and laminates that are not necessarily suitable for drilling and tapping, any drilled and tapped holes could be replaced with metal threaded inserts, such as tapped standoffs or T-nuts, wherein the metal threaded inserts could be held in their proper positions using an appropriate adhesive or an appropriate mechanical means. The work support element support legs could be made of wood, similar to a folding TV tray. The work support element could be supported by four individual legs of a short length suitable for free-standing on top of a workbench or work table, herein referred to as short legs, reference numeral 69, FIG. 10A. The work support element could be supported by four individual legs of a longer length suitable for free-standing on the floor allowing an operator to either sit or stand, herein referred to as long legs, reference numeral 70, FIG. 10B. The work support element could be supported by a generic metal tool stand, reference numeral 71, FIG. 10C. The work support element could be supplied with any necessary mounting adapters thereby allowing for temporary attachment to a folding clamp table or other existing suitable work support element area, herein referred to as clamp table adapters, reference numeral 72, FIG. 10D. The work support element could be supported by clampable supports allowing for free-standing use with the ability to temporarily and firmly clamp the assembly to existing work tables or benches, herein referred to as clampable supports, reference numeral 73, FIG. 10E. The work support element could be flush mounted directly to a workbench or work table, FIG. 10F. The work support element can also be made to incorporate a straight groove suitable for a miter guide and the assembly can be made available with a miter guide whereby the miter guide slidably operates in concert with the straight groove in the work support element thereby allowing the operator to make straight cuts at any desired angle. Shapes and sizes of the various pieces can be altered to satisfy various mechanical or ergonomic/human engineering needs. Applications can include, but are not limited to, odd jobs, home repair jobs, Do-It-Yourself projects, arts and crafts including country crafts and fancy wall tile mosaics, hobby projects including model airplanes, model boats, model train layouts, dollhouses, and professional model building.

### CONCLUSION, RAMIFICATIONS, AND SCOPE OF INVENTION

Accordingly, the reader will see that the rotary saw table and method for adapting various rotary saws of the subject invention provides a very versatile, easy-to-use, reliable, economical device that can be used to perform various types of work, including fine detail work, on numerous types of materials with numerous types of cutting bits. Furthermore, my rotary saw table and method for adapting various rotary saws has the additional advantages in that
its design is very innovative by completely eliminating the overhead support arm for the cutting member, such as is found on scroll saws, thereby eliminating x- and y-dimension size constraints on the work piece;
its design allows a rotary saw to function as a scroll saw, thereby eliminating the need to have a separate scroll saw, and eliminating the expense of a separate scroll saw, in one's workshop;
it serves as an attachment, in its various possible configurations, for existing rotary saws offered by a plurality of manufacturers thereby making it more economical for hobbyists and professional consumers to expand the capabilities of their workshop while being able to avoid the extra cost of a built-in motor and its associated parts as is found in existing scroll saws;
its design can be adapted to accommodate all styles of rotary saw made by a plurality of manufacturers instead of being dedicated to just one or two types of rotary saws thereby making it a much more versatile and broadly applied product;
it allows the consumer the option of using his or her existing rotary saws and cutting bits thereby making it even more economical and attractive for the consumer;
it is mechanically very simple as compared to existing scroll saws and it comprises a minimum number of pieces thereby making it economical and reliable;
its design does not include any moving pieces thereby making it very reliable;
its simplicity allows for quick and easy assembly and mating to rotary saws while requiring no assembly tools during normal use;
in combination with its high-speed, rotating cutter it allows for material cutting and/or material removal in any direction without specifically having to rotate the work piece to align with a blade, as is necessary with a scroll saw or a band saw; and
its design, wherein the rotary saw is securely mounted in concert with a work support element, allows for use with delicate work pieces by freeing up both of the operator's hands to provide positive control of the work piece.

While my above description contains many specificities, these should not be construed as limitations on the scope of my rotary saw table and method for adapting various rotary saws, but rather as an exemplification of one preferred embodiment thereof. Many other variations are possible. For example, the work support element can be made to have more surface area or less surface area; the work support element can be made round or rectangular with rounded corners instead of square with rounded corners; the work support element can include recessed holes instead of countersunk holes to accommodate different styles of screws; the work support element can have an attached, lower tray for holding extra bits and tools; the work support element support legs can be made to be shorter for use on workbench surfaces, or taller for standup use on floors; the pieces can be made in different colors and/or types of surface finishes; clearance holes can be changed to threaded holes and threaded holes can be changed to clearance holes; the various pieces can be made out of various materials; the various pieces of my rotary saw table and method for adapting various rotary saws can be made using various manufacturing methods, including but not limited to, machining, casting, molding, casting with secondary machining, molding with secondary machining, and metal injection molding; the thumbscrews, used for securing the side brackets and the vertical bracket in position, can be replaced with a plurality of thumbscrews, or set screws, or a twist-lock mechanism, or various other methods of securing the parts of my rotary saw table and method for adapting various rotary saws to rotary saw table.

Thus the scope of my rotary saw table and method for adapting various rotary saws to rotary saw table should be determined by the appended claims and their legal equivalents, rather than by examples given.

1. A method for mounting one of a plurality of rotary saws to a work support element assembly comprising the steps of:
a. providing a work support element having a top side and an underside and having a through hole connecting said top side and said underside, and
b. providing a suitable work support element support and affixing said work support element support to the underside of said work support element, and
c. providing a mounting apparatus suitable for rotary saws and affixing said mounting apparatus to the underside of said work support element, and
d. mounting one of a plurality of rotary saws with an attached cutting bit to said mounting apparatus on the underside of said work support element such that said rotary saw is firmly captivated in the x-, y-, and z-axes and such that said cutting bit extends through said through hole and above said top side of said work support element and such that said cutting bit is approximately perpendicular to said top side of said work support element.

2. A rotary saw table assembly.

3. The rotary saw table assembly of claim 2 comprising a work support element, a means of supporting said work support element, a means for adapting one of a plurality of rotary saws to said assembly, a means for securing one of a plurality of rotary saws to said assembly, and a means for adapting a vacuum to said assembly.

4. The work support element of claim 3 wherein said work support element has a suitably shaped plan form and wherein said work support element has an undersurface and wherein said work support element has a generous surface area and an adequate thickness and wherein said work support element is generally of the same material thickness and wherein said work support element includes a plurality of mounting points for mounting said means of supporting said work support element to said work support element and for mounting said means for adapting a vacuum to said assembly and wherein said work support element includes a clearance hole for said rotary cutting bit of said rotary saw and wherein said work support element includes a plurality of mounting points for mounting said means for securing one of a plurality of rotary saws with rotary cutting bit to said work support element.

5. The means of supporting said work support element of claim 3 wherein said means comprising a first support assembly and a second support assembly.

6. The first support assembly of claim 5 wherein said assembly comprising two identical tubular pieces that are joined together and wherein each said tubular piece has a first straight segment and wherein one end of said first straight segment transitions into a right angle bend and wherein the other end of said first straight segment transitions into a right angle bend and wherein each said right angle bend is of approximately equal radius and wherein both said right angle bends are coplanar and wherein each said right angle bend is made to be in the same direction and wherein one right angle bend transitions into a second straight segment and wherein the other right angle bend transitions into a third straight segment and wherein said second and third straight segments are of approximately equal length and wherein said second and third straight segments are shorter than the first straight segment and wherein said second straight segment is not swaged and wherein third straight segment is swaged to a lesser diameter for a length less than the overall length of said third straight segment and wherein said less length includes the outside end of said third straight segment and wherein said lesser diameter is such that it will slideably fit inside like tubular material that has not been swaged to a lesser diameter and wherein there is a hole in both sides of the tubular walls of said first straight segment of each tubular piece such that the centers of each said hole forms a first imaginary line that intersects approximately perpendicularly the longitudinal axis of said first straight segment and wherein said first imaginary line is also coplanar with said right angle bends and wherein said first imaginary line is located at a distance between one end of said first straight segment and the midpoint of said first straight segment of each tubular piece and wherein there is another set of holes similarly positioned between the other end of said first straight segment and the midpoint of said first straight segment of each tubular piece such that said holes in said first straight segment of each tubular piece are approximately coaxially aligned with each other and with corresponding holes of said second support assembly and wherein said first imaginary lines are located along the length of each said first segment such that said first support assembly can be attached to said second support assembly by way of a screw or other pinning device through said holes in said first straight segments such that each support assembly is allowed to rotate in relation to each other about the point of attachment such that said first support assembly and said second support assembly can be positioned into their intended position relative to each other and relative to said work support element for mating to said work support element such that the plane of said work support element, when properly mated, is approximately parallel to a plane that is tangent to said first support assembly and said second support assembly at their extremities opposite to said work support element.

7. The second support assembly of claim 5 wherein said assembly comprising two identical tubular pieces and wherein said each tubular piece has a first straight segment and wherein said first straight segment of each said tubular piece of said second support assembly is shorter than said first straight segment of each said tubular piece of said first support assembly and wherein one end of said first straight segment of each said tubular piece of said second support assembly transitions into a right angle bend and wherein the other end of said first straight segment of each said tubular piece of said second support assembly transitions into a right angle bend and wherein each said right angle bend is of approximately equal radius and wherein both said right angle bends are coplanar and wherein each said right angle bend is made to be in the same direction and wherein one right angle bend transitions into a second straight segment and wherein the other right angle bend transitions into a third straight segment and wherein said second and third straight segments are of approximately equal length and wherein said second and third straight segments are shorter than the first straight segment and wherein said second and third straight segments of each said tubular piece of said second support assembly are shorter than said second and third straight segments of each said tubular piece of said first support assembly and wherein said second straight segment is not swaged and wherein third straight segment is swaged to a lesser diameter for a length less than the overall length of said third straight segment and wherein said less length includes the outside end of said third straight segment and wherein said lesser diameter is such that it will slideably fit inside like tubular material that has not been swaged to a lesser diameter and wherein there is a hole in both sides of the tubular walls of said first straight segment of each tubular piece such that the centers of each said hole forms a first imaginary line that intersects approximately perpendicularly the longitudinal axis of said first straight segment and wherein said first imaginary line is also coplanar with said right angle bends and wherein said first imaginary line is located at a distance between one end of said first straight segment and the midpoint of said first straight segment of each tubular piece and wherein there is another set of holes similarly positioned between the other end of said first straight segment and the midpoint of said first straight segment of each tubular piece such that said holes in said first straight segment of each tubular piece are approximately coaxially aligned with each other and with corresponding holes of said first support assembly and wherein said first imaginary lines are located along the length of each said first segment such that said second support assembly can be attached to said first support assembly by way of a screw or other pinning device through said holes in said first straight segments such that each support assembly is allowed to rotate in relation to each other about the point of attachment such that said first support assembly and said second support assembly can be positioned into their intended position relative to each other and relative to said work support element for mating to said work support element such that the plane of said work support element, when properly mated, is approximately parallel to a plane that is tangent to said first support assembly and said second support assembly at their extremities opposite to said work support element and wherein said segment lengths and said radius bends of each said tubular piece of said second support assembly are such that said second support assembly will fit within the confines of the inside dimensions of said first support assembly.

8. The means for adapting one of a plurality of rotary saws to said assembly of claim 3 wherein said means is one of a plurality of one-piece adapters comprising adapters of a first style, adapters of a second style, adapters of a third style, adapters of a fourth style, and adapters of a fifth style.

9. The adapters of a first style of claim 8 wherein said adapters of a first style is a plurality of one-piece adapters wherein one of a plurality of said adapters is matched to the particular rotary saw to be utilized and wherein each of said adapters is generally cylindrical and wherein each of said adapters has a major diameter, hereafter referred to as a first diameter, wherein said first diameters are approximately equal and wherein each of said adapters has a first end and wherein each of said adapters has a second end and wherein each of said adapters has an overall length, hereafter referred to as a first length, and wherein said first length of each adapter can be unique for each adapter and wherein said first end of each adapter has a second diameter less than said first diameter and wherein said second diameters are approximately equal and wherein said second diameter extends longitudinally along the length of each adapter for a second length and wherein said second length is shorter than said first length and wherein said second length has an end point and wherein said second lengths are approximately equal and wherein each of said adapters has a bore, hereafter referred to as first bore, between said first end and said second end and wherein said first bore has a minor diameter, hereafter referred to as a third diameter, and a major diameter, hereafter referred to as a fourth diameter, and wherein said third diameter and said fourth diameter are coaxial in relation to each other and are coaxial in relation to longitudinal axis of each said adapter and wherein said third diameter is less than said second diameter and wherein said fourth diameter is less than said first diameter and wherein said third diameter extends longitudinally along the length of each adapter for a length, hereafter referred to as a third length, and wherein said third length originates at said first end and wherein said third length terminates between said first end and said second end and wherein said third length is less than said first length and wherein said third length has an end point and wherein said fourth diameter extends longitudinally along the length of each adapter for a length, hereafter referred to as a fourth length, and wherein said fourth length originates at said second end and wherein said fourth length is less than said first length and wherein said fourth length terminates at the same end point that said third length terminates and wherein said fourth diameter and said fourth length are sized to adequately capture the bit end of the body of said rotary saw such that movement between said adapter and said rotary saw along the x-axis and y-axis is minimized and wherein said third diameter allows adequate clearance for the collet and tightening nut of said rotary saw to rotate without interference and wherein said first length and said second length and said third length and said fourth length are sized such that when said adapter and said rotary saw are properly mated in relation to each other the bit insertion end of the collet and tightening nut of said rotary saw is approximately coplanar with said first end and wherein each of said adapters has a bore, hereafter referred to as second bore, through said first diameter such that the longitudinal axis of said second bore intersects longitudinal axis of said adapter approximately perpendicularly and wherein each said second bore has a diameter, hereafter referred to as a fifth diameter, and wherein said fifth diameters of each of said second bores of each of said adapters are approximately equal and wherein said fifth diameter is made to be less than the distance between said end point of said second length and said end point of said third length and wherein said second bore is located between said end point of said second length and said end point of said third length and wherein each of said adapters has a trough or void, hereafter referred to as a trough, in said first end of said adapter and wherein the cross section of said trough along the longitudinal axis of said adapter is approximately rectangular in shape and wherein said trough depth along the longitudinal axis of said adapter between said first end of said adapter and the floor of said trough is approximately equal to said second length and wherein the cross section of said trough along a radial of said adapter, hereafter referred to as radial cross section, is centered about a radial extending from the longitudinal axis of said adapter to the outside surface of said adapter defined by said first diameter and wherein said radial cross section is bordered by, and open between, said second diameter and said third diameter and wherein width of said radial cross section of said trough is approximately constant and is approximately equal to said third diameter.

10. The adapters of a second style of claim 8 wherein said adapters of a second style is a plurality of one-piece adapters wherein one of a plurality of said adapters is matched to the particular rotary saw to be utilized and wherein each of said adapters is generally cylindrical and wherein each of said adapters has a major diameter, hereafter referred to as a first diameter, wherein said first diameters are approximately equal and wherein each of said adapters has a first end and wherein each of said adapters has a second end and wherein each of said adapters has an overall length, hereafter referred to as a first length, and wherein said first length of each adapter can be unique for each adapter and wherein said first end of each adapter has a second diameter less than said first diameter and wherein said second diameters are approximately equal and wherein said second diameter extends longitudinally along the length of each adapter for a second length and wherein said second length is shorter than said first length and wherein said second length has an end point and wherein said second lengths are approximately equal and wherein each of said adapters has a bore, hereafter referred to as first bore, between said first end and said second end and wherein said first bore has a minor diameter, hereafter referred to as a third diameter, and a major diameter, hereafter referred to as a fourth diameter, and wherein said third diameter and said fourth diameter are coaxial in relation to each other and are coaxial in relation to longitudinal axis of each said adapter and wherein said third diameter is less than said second diameter and wherein said fourth diameter is less than said first diameter and wherein said third diameter extends longitudinally along the length of each adapter for a length, hereafter referred to as a third length, and wherein said third length originates at said first end and wherein said third length terminates between said first end and said second end and wherein said third length is less than said first length and wherein said third length has an end point and wherein said fourth diameter extends longitudinally along the length of each adapter for a length, hereafter referred to as a fourth length, and wherein said fourth length originates at said second end and wherein said fourth length is less than said first length and wherein said fourth length terminates at the same end point that said third length terminates and wherein said fourth diameter and said fourth length are sized to adequately capture the bit end of the body of said rotary saw such that movement between said adapter and said rotary saw along the x-axis and y-axis is minimized and wherein said third diameter allows adequate clearance for the collet and tightening nut of said rotary saw to rotate without interference and wherein said first length and said second length and said third length and said fourth length are sized such that when said adapter and said rotary saw are properly mated in relation to each other the bit insertion end of the collet and tightening nut of said rotary saw is approximately coplanar with said first end and wherein each of said adapters has a bore, hereafter referred to as second bore, through said first diameter such that the longitudinal axis of said second bore intersects longitudinal axis of said adapter approximately perpendicularly and wherein each said second bore has a diameter, hereafter referred to as a fifth diameter, and wherein said fifth diameters of each of said second bores of each of said adapters are approximately equal and wherein said fifth diameter is made to be less than the distance between said end point of said second length and said end point of said third length and wherein said second bore is located between said end point of said second length and said end point of said third length and wherein there is a straight groove in the side of said adapter and wherein said groove extends parallel to said longitudinal axis of said adapter and wherein said groove extends between, and includes, said first end and said second end of said adapter and wherein said groove has a predetermined cross-sectional shape and wherein said groove depth is bounded by said first diameter and said fourth diameter and wherein said predetermined cross-sectional shape of said groove is adequately sized to slideably fit around a key that is a portion of the bit end of the body of said rotary saw and wherein said groove contributes to the proper mating of said adapter to said rotary saw and wherein each of said adapters has a trough or void, hereafter referred to as a trough, in said first end of said adapter and wherein the cross section of said trough along the longitudinal axis of said adapter is approximately rectangular in shape and wherein said trough depth along the longitudinal axis of said adapter between said first end of said adapter and the floor of said trough is approximately equal to said second length and wherein the cross section of said trough along a radial of said adapter, hereafter referred to as radial cross section, is centered about a radial extending from the longitudinal axis of said adapter to the outside surface of said adapter defined by said first diameter and wherein said radial cross section is bordered by, and open between, said second diameter and said third diameter and wherein width of said radial cross section of said trough is approximately constant and is approximately equal to said third diameter.

11. The adapters of a third style of claim 8 wherein said adapters of a third style is a plurality of one-piece adapters wherein one of a plurality of said adapters is matched to the particular rotary saw to be utilized and wherein each of said adapters is generally cylindrical and wherein each of said adapters has a major diameter, hereafter referred to as a first diameter, wherein said first diameters are approximately equal and wherein each of said adapters has a first end and wherein each of said adapters has a second end and wherein each of said adapters has an overall length, hereafter referred to as a first length, and wherein said first length of each adapter can be unique for each adapter and wherein said first end of each adapter has a second diameter less than said first diameter and wherein said second diameters are approximately equal and wherein said second diameter extends longitudinally along the length of each adapter for a second length and wherein said second length is shorter than said first length and wherein said second length has an end point and wherein said second lengths are approximately equal and wherein each of said adapters has a bore, hereafter referred to as first bore, between said first end and said second end and wherein said first bore has a minor diameter, hereafter referred to as a third diameter, and a major diameter, hereafter referred to as a fourth diameter, and wherein said third diameter and said fourth diameter are coaxial in relation to each other and are coaxial in relation to longitudinal axis of each said adapter and wherein said third diameter is less than said second diameter and wherein said fourth diameter is less than said first diameter and wherein said third diameter extends longitudinally along the length of each adapter for a length, hereafter referred to as a third length, and wherein said third length originates at said first end and wherein said third length terminates between said first end and said second end and wherein said third length is less than said first length and wherein said third length has an end point and wherein said fourth diameter extends longitudinally along the length of each adapter for a length, hereafter referred to as a fourth length, and wherein said fourth length originates at said second end and wherein said fourth length is less than said first length and wherein said fourth length terminates at the same end point that said third length terminates and wherein said fourth diameter and said fourth length are sized to adequately capture the bit end of the body of said rotary saw such that movement between said adapter and said rotary saw along the x-axis and y-axis is minimized and wherein said third diameter allows adequate clearance for the collet and tightening nut of said rotary saw to rotate without interference and wherein said first length and said second length and said third length and said fourth length are sized such that when said adapter and said rotary saw are properly mated in relation to each other the bit insertion end of the collet and tightening nut of said rotary saw is approximately coplanar with said first end and wherein each of said adapters has a trough or void, hereafter referred to as a trough, in said first end of said adapter and wherein the cross section of said trough along the longitudinal axis of said adapter is approximately rectangular in shape and wherein said trough depth along the longitudinal axis of said adapter between said first end of said adapter and the floor of said trough is approximately equal to said second length and wherein the cross section of said trough along a radial of said adapter, hereafter referred to as radial cross section, is centered about a radial extending from the longitudinal axis of said adapter to the outside surface of said adapter defined by said first diameter and wherein said radial cross section is bordered by, and open between, said second diameter and said third diameter and wherein width of said radial cross section of said trough is approximately constant and is approximately equal to said third diameter.

12. The adapters of a fourth style of claim 8 wherein said adapters of a fourth style is a plurality of one-piece adapters wherein one of a plurality of said adapters is matched to the particular rotary saw to be utilized and wherein each of said adapters is generally cylindrical and wherein each of said adapters has a major diameter, hereafter referred to as a first diameter, wherein said first diameters are approximately equal and wherein each of said adapters has a first end and wherein each of said adapters has a second end and wherein each of said adapters has an overall length, hereafter referred to as a first length, and wherein said first length of each adapter can be unique for each adapter and wherein said first end of each adapter has a second diameter less than said first diameter and wherein said second diameters are approximately equal and wherein said second diameter extends longitudinally along the length of each adapter for a second length and wherein said second length is shorter than said first length and wherein said second length has an end point and wherein said second lengths are approximately equal and wherein each of said adapters has a bore, hereafter referred to as first bore, between said first end and said second end and wherein said first bore has a minor diameter, hereafter referred to as a third diameter, and a major diameter, hereafter referred to as a fourth diameter, and wherein said third diameter and said fourth diameter are coaxial in relation to each other and are coaxial in relation to longitudinal axis of each said adapter and wherein said third diameter is less than said second diameter and wherein said fourth diameter is less than said first diameter and wherein said third diameter extends longitudinally along the length of each adapter for a length, hereafter referred to as a third length, and wherein said third length originates at said first end and wherein said third length terminates between said first end and said second end and wherein said third length is less than said first length and wherein said third length has an end point and wherein said fourth diameter is coplanar with said second end and wherein the plane of the fourth diameter, which is the same as the plane of said second end, and the plane of the third diameter are separated by a distance, hereafter referred to as a fourth length, and wherein said fourth length originates at said second end and wherein said fourth length is less than said first length and wherein said fourth length terminates at the same end point that said third length terminates and wherein said fourth diameter and said third diameter and said fourth length define a conical bore with linear inner walls that are tangent to said fourth diameter and said third diameter and wherein said fourth diameter and said fourth length and the resulting conical bore bordered by said fourth diameter and said third diameter are sized to adequately capture the bit end of the body of said rotary saw such that movement between said adapter and said rotary saw along the x-axis and y-axis is minimized and wherein said third diameter allows adequate clearance for the collet and tightening nut of said rotary saw to rotate without interference and wherein said first length and said second length and said third length and said fourth length are sized such that when said adapter and said rotary saw are properly mated in relation to each other the bit insertion end of the collet and tightening nut of said rotary saw is approximately coplanar with said first end and wherein each of said adapters has a bore, hereafter referred to as second bore, through said first diameter such that the longitudinal axis of said second bore intersects longitudinal axis of said adapter approximately perpendicularly and wherein each said second bore has a diameter, hereafter referred to as a fifth diameter, and wherein said fifth diameters of each of said second bores of each of said adapters are approximately equal and wherein said fifth diameter is made to be less than the distance between said end point of said second length and said end point of said third length and wherein said second bore is located between said end point of said second length and said end point of said third length and wherein each of said adapters has a trough or void, hereafter referred to as a trough, in said first end of said adapter and wherein the cross section of said trough along the longitudinal axis of said adapter is approximately rectangular in shape and wherein said trough depth along the longitudinal axis of said adapter between said first end of said adapter and the floor of said trough is approximately equal to said second length and wherein the cross section of said trough along a radial of said adapter, hereafter referred to as radial cross section, is centered about a radial extending from the longitudinal axis of said adapter to the outside surface of said adapter defined by said first diameter and wherein said radial cross section is bordered by, and open between, said second diameter and said third diameter and wherein width of said radial cross section of said trough is approximately constant and is approximately equal to said third diameter.

13. The adapters of a fifth style of claim 8 wherein said adapters of a fifth style is a plurality of one-piece adapters wherein one of a plurality of said adapters is matched to the particular rotary saw to be utilized and wherein each of said adapters is generally cylindrical and wherein each of said adapters has a major diameter, hereafter referred to as a first diameter, wherein said first diameters are approximately equal and wherein each of said adapters has a first end and wherein each of said adapters has a second end and wherein each of said adapters has an overall length, hereafter referred to as a first length, and wherein said first length of each adapter can be unique for each adapter and wherein said first end of each adapter has a second diameter less than said first diameter and wherein said second diameters are approximately equal and wherein said second diameter extends longitudinally along the length of each adapter for a second length and wherein said second length is shorter than said first length and wherein said second length has an end point and wherein said second lengths are approximately equal and wherein each of said adapters has a bore, hereafter referred to as first bore, between said first end and said second end and wherein said first bore has a minor diameter, hereafter referred to as a third diameter, and a major diameter, hereafter referred to as a fourth diameter, and wherein said third diameter and said fourth diameter are coaxial in relation to each other and are coaxial in relation to longitudinal axis of each said adapter and wherein said third diameter is less than said second diameter and wherein said fourth diameter is less than said first diameter and wherein said third diameter extends longitudinally along the length of each adapter for a length, hereafter referred to as a third length, and wherein said third length originates at said first end and wherein said third length terminates between said first end and said second end and wherein said third length is less than said first length and wherein said third length has an end point and wherein said fourth diameter extends longitudinally along the length of each adapter for a length, hereafter referred to as a fourth length, and wherein said fourth length originates at said second end and wherein said fourth length is less than said first length and wherein said fourth length has an end point and wherein said fourth length terminates at said end point and wherein there is another length between said end point of said fourth length and said end point of said third length, hereafter referred to as a fifth length, and wherein said fifth length is less than said first length and wherein said fourth diameter and said third diameter and said fifth length define a conical bore with linear inner walls that are tangent to said fourth diameter and said third diameter and wherein said fourth diameter and said fourth length and said fifth length and the resulting conical bore bordered by said fourth diameter and said third diameter are sized to adequately capture the bit end of the body of said rotary saw such that movement between said adapter and said rotary saw along the x-axis and y-axis is minimized and wherein said third diameter allows adequate clearance for the collet and tightening nut of said rotary saw to rotate without interference and wherein said first length and said second length and said third length and said fourth length and said fifth length are sized such that when said adapter and said rotary saw are properly mated in relation to each other the bit insertion end of the collet and tightening nut of said rotary saw is approximately coplanar with said first end and wherein each of said adapters has a bore, hereafter referred to as second bore, through said first diameter such that the longitudinal axis of said second bore intersects longitudinal axis of said adapter approximately perpendicularly and wherein each said second bore has a diameter, hereafter referred to as a fifth diameter, and wherein said fifth diameters of each of said second bores of each of said adapters are approximately equal and wherein said fifth diameter is made to be less than the distance between said end point of said second length and said end point of said third length and wherein said second bore is located between said end point of said second length and said end point of said third length and wherein each of said adapters has a trough or void, hereafter referred to as a trough, in said first end of said adapter and wherein the cross section of said trough along the longitudinal axis of said adapter is approximately rectangular in shape and wherein said trough depth along the longitudinal axis of said adapter between said first end of said adapter and the floor of said trough is approximately equal to said second length and wherein the cross section of said trough along a radial of said adapter, hereafter referred to as radial cross section, is centered about a radial extending from the longitudinal axis of said adapter to the outside surface of said adapter defined by said first diameter and wherein said radial cross section is bordered by, and open between, said second diameter and said third diameter and wherein width of said radial cross section of said trough is approximately constant and is approximately equal to said third diameter.

14. The means for securing one of a plurality of rotary saws to said assembly of claim 3 wherein said means comprises a rotary saw mount, a rotary saw mount vertical bracket, an optional rotary saw mount vertical bracket doubler, a plurality of rotary saw mount side brackets, a means of securing said rotary saw mount vertical bracket wherein said means of securing said rotary saw mount vertical bracket comprises a plurality of appropriately sized thumbscrews, a means of securing said optional rotary saw mount vertical bracket doubler wherein said means of securing said optional rotary saw mount vertical bracket doubler comprises a plurality of appropriately sized screws, and a means of securing said plurality of rotary saw mount side brackets wherein said means of securing said plurality of rotary saw mount side brackets comprises a plurality of appropriately sized thumbscrews.

15. The rotary saw mount of claim 14 wherein said mount is of one-piece construction and wherein said mount has a first and a second vertical sidewall of approximately equal dimensions, thickness, and shape and in aposition to each other and wherein said mount has a third, horizontal sidewall approximately equal in thickness to said first and second sidewalls and wherein said third sidewall is positioned between said first and second sidewall such that said mount is generally an inverted U-shape and wherein said first and second vertical sidewalls each lie in separate planes that are approximately parallel to each other and wherein said third sidewall lies in a plane that is approximately perpendicular to the planes associated with said first and second sidewalls and wherein the thickness of all three sidewalls of said mount is generally uniform and approximately equal and wherein said sidewall thickness is adequate for drilling and tapping of appropriately sized mounting holes in any axis and wherein the dimensions of said third sidewall, and the resulting distance between said first and second vertical sidewalls, is chosen to adequately accommodate the major diameter any one of a plurality of said rotary saws and wherein said sidewalls have an edge of said uniform thickness, hereafter referred to as the first edge, and wherein said sidewalls have another edge of said uniform thickness, hereafter referred to as the second edge, and wherein said third sidewall contains a large diameter through hole, hereafter referred to as the first hole, that is approximately centered within the third sidewall and wherein said first hole is approximately perpendicular to the plane of said third sidewall and wherein said first hole is sized to snuggly capture said first end of any one of a plurality said adapters and wherein said first hole is adjoined with a slot shaped void, hereafter referred to as a slot, that together form a generally keyhole shaped void and wherein said slot is of generally constant width and wherein said slot is centered about an imaginary radial that originates at the center of said first hole and that is generally perpendicular to said second edge and wherein said slot extends through said second edge such that a center section of said second edge is removed and wherein said third sidewall contains another hole, hereafter referred to as the second hole, that is approximately perpendicular to the plane of said third sidewall and wherein said second hole is of lesser diameter than said first hole and wherein said second hole is located approximately midway between said first edge and said second edge and generally centered on a centerline common to said first hole and wherein said second hole is also located between the edge of said first hole and said first sidewall and wherein said third sidewall contains another hole, hereafter referred to as the third hole, that is approximately perpendicular to the plane of said third sidewall and wherein said third hole is approximately equal in diameter to said second hole and wherein said third hole is located approximately midway between said first edge and said second edge and generally centered on a centerline common to said first hole and said second hole and wherein said third hole is also located between the edge of said first hole and said second sidewall and wherein said second hole and said third hole positions match corresponding holes in said work support element such that said mount can be firmly affixed to the underside of said work support element and wherein said mount has another edge, hereafter referred to as the first end, and wherein said mount has another edge, hereafter referred to as the second end, and wherein said first end has a mounting hole having an adequate depth, hereafter referred to as the fourth hole, and wherein said fourth hole is generally perpendicular to said first end and wherein said first end has another mounting hole having an adequate depth, hereafter referred to as the fifth hole, and wherein said fifth hole is generally perpendicular to said first end and wherein said fourth hole and said fifth hole are generally located on a centerline of the first end between said first edge and said second edge and wherein said fourth hole is also located closer to said first edge than to said second edge and wherein said fifth hole is also located closer to said second edge than to said first edge and wherein said fourth hole and said fifth hole positions match corresponding slots in rotary saw mount side brackets such that said side brackets can be affixed to said first end in their intended positions relative to each other and wherein said second end has a mounting hole having an adequate depth, hereafter referred to as the sixth hole, and wherein said sixth hole is generally perpendicular to said second end and wherein said second end has another mounting hole having an adequate depth, hereafter referred to as the seventh hole, and wherein said seventh hole is generally perpendicular to said second end and wherein said sixth hole and said seventh hole are generally located on a centerline of the second end between said first edge and said second edge and wherein said sixth hole is also located closer to said first edge than to said second edge and wherein said seventh hole is also located closer to said second edge than to said first edge and wherein said sixth hole and said seventh hole positions match corresponding slots in rotary saw mount side brackets such that said side brackets can be affixed to said second end in their intended positions relative to each other and wherein said first edge has a hole having an adequate depth, hereafter referred to as the eighth hole, and wherein said first edge has another hole having an adequate depth, hereafter referred to as the ninth hole, and wherein said eighth and ninth holes are approximately centered on an imaginary surface line that bisects the thickness of said first edge and wherein said eighth hole is also an appropriate distance from said first end and wherein said ninth hole is also an appropriate distance from said eighth hole and wherein said eighth hole is between said first end and said ninth hole and wherein said eighth and ninth holes do not overlap and wherein said first edge has another hole having an adequate depth, hereafter referred to as the tenth hole, and wherein said first edge has another hole having an adequate depth, hereafter referred to as the eleventh hole, and wherein said tenth and eleventh holes are approximately centered on an imaginary surface line that bisects the thickness of said first edge and wherein said tenth hole is also an appropriate distance from said second end and wherein said eleventh hole is also an appropriate distance from said tenth hole and wherein said tenth hole is between said second end and said eleventh hole and wherein said tenth and eleventh holes do not overlap and wherein said eighth and tenth holes are approximately an equal distance from said first end and said second end respectively and wherein said ninth and eleventh holes are approximately an equal distance from said first end and said second end respectively and wherein said eighth and tenth holes match corresponding slots in a rotary saw mount vertical bracket and wherein said eighth and tenth holes allow for attachment of a rotary saw mount vertical bracket to said rotary saw mount as an aid in firmly captivating certain styles of rotary saws and wherein said ninth and eleventh holes match corresponding slots in a rotary saw mount vertical bracket and wherein said ninth and eleventh holes also allow for attachment of a rotary saw mount vertical bracket to said rotary saw mount as an aid in firmly captivating other styles of rotary saws.

16. The rotary saw mount vertical bracket of claim 14 wherein said vertical bracket is of one-piece construction and wherein said vertical bracket is made to be firmly affixed to the first edge of said rotary saw mount and wherein said vertical bracket is intended to be removable and wherein said vertical bracket has an edge, hereafter referred to as the first edge, and wherein said vertical bracket has another edge, hereafter referred to as the second edge, and wherein said vertical bracket has another edge, hereafter referred to as the third edge, and wherein said vertical bracket has another edge, hereafter referred to as the fourth edge, and wherein said first and second and third and fourth edges are generally of the same material thickness and wherein all of said vertical bracket is generally of the same material thickness and wherein said first and third edges are generally parallel to each other and wherein said second and fourth edges are generally parallel to each other and wherein said first and third edges are generally perpendicular to said second and fourth edges and wherein said second and fourth edges are of a length adequate to span across said eighth and tenth holes of said rotary saw mount and wherein said vertical bracket has a void, hereafter referred to as the first void, and wherein said first void has a side that is both relatively close to said first edge and generally parallel to said first edge and wherein said first void extends to and through said first edge such that said first void is bounded only by three sides and wherein the other two sides of said first void are generally parallel to each other and to said second and fourth edges and wherein said vertical bracket has another void, hereafter referred to as the second void, and wherein said second void is generally closer to said second and third edges and wherein said second void includes a first slot-shaped section that is generally parallel to said third edge and wherein said second void includes a second slot-shaped section that is generally parallel to said second edge and wherein said second slot-shaped section is generally perpendicular to said first slot-shaped section and wherein second slot-shaped section is generally positioned between said first slot-shaped section and said first edge and wherein one end of said second slot-shaped section is connected to the side of said first slot-shaped section and wherein said second void also includes a generally circular-shaped section and wherein said circular-shaped section is of adequate diameter to allow the head of a thumbscrew to pass through and wherein said circular-shaped section is generally positioned between said second slot-shaped section and said first edge and wherein one edge of said circular-shaped section is connected to the end of said second slot-shaped section thereby forming one complex void, referred to as the second void, and wherein said slot-shaped sections are wide enough to allow slideable clearance from the threaded shaft of a suitable thumbscrew and wherein said first void and the first slot-shaped section of said second void are generally centered on a centerline connecting the midpoints of said first edge and said third edge and wherein the dimensions of said first void and the first slot-shaped section of said second void, that are generally perpendicular to said centerline, are generally equal dimensions and wherein the dimension between the inside edge of said first void and the inside edge of said first slot-shaped section of said second void is such that it generally is equal to the dimension between said eighth and tenth holes of said rotary saw mount and wherein said vertical bracket has a hole, hereafter referred to as the first hole, and wherein said vertical bracket has another hole, hereafter referred to as the second hole, and wherein said first hole and said second hole are generally the same diameter and wherein said first hole and said second hole are on a line generally parallel to said second edge and wherein said first hole and said second hole are generally aligned with corresponding holes in a vertical bracket doubler and wherein said first hole and said second hole are each made to accept a suitable means for securing a vertical bracket doubler to said vertical bracket as required and such that said vertical bracket, along with a vertical bracket doubler if required based on the style of said rotary saw, can be adjusted in position and firmly affixed to said first edge of said rotary saw mount in a position such that said vertical bracket can capture said rotary saw in its proper, desired position along the z-axis.

17. The rotary saw mount vertical bracket doubler of claim 14 wherein said vertical bracket doubler is of one-piece construction and wherein said vertical bracket doubler is optional and serves to aid said rotary saw vertical bracket in captivating certain styles of rotary saws and wherein said vertical bracket doubler has an edge, hereafter referred to as the first edge, and wherein said vertical bracket doubler has another edge, hereafter referred to as the second edge, and wherein said vertical bracket doubler has another edge, hereafter referred to as the third edge, and wherein said vertical bracket doubler has another edge, hereafter referred to as the fourth edge, and wherein said first and second and third and fourth edges are generally of the same material thickness and wherein all of said vertical bracket doubler is generally of the same material thickness and wherein said first and third edges are generally parallel to each other and wherein said second and fourth edges are generally parallel to each other and wherein said first and third edges are generally perpendicular to said second and fourth edges and wherein said vertical bracket doubler has a hole, hereafter referred to as the first hole, and wherein said vertical bracket doubler has another hole, hereafter referred to as the second hole, and wherein said first hole and said second hole are generally the same diameter and wherein said first hole and said second hole are on a line generally parallel to said second edge and wherein said first hole and said second hole are generally aligned with corresponding holes in said rotary saw vertical bracket and wherein said first hole and said second hole are each made to accept a suitable means for securing said vertical bracket doubler to said rotary saw vertical bracket as required.

18. The plurality of rotary saw mount side brackets of claim 14 wherein said side bracket is of one-piece construction and wherein a plurality of said side brackets serve to captivate the lower body of said rotary saw in both the x-axis and the y-axis and wherein said side bracket has an edge, hereafter referred to as the first edge, and wherein said side bracket has another edge, hereafter referred to as the second edge, and wherein said side bracket has another edge, hereafter referred to as the third edge, and wherein said side bracket has another edge, hereafter referred to as the fourth edge, and wherein said first and second and third and fourth edges are generally of the same material thickness and wherein all of said side bracket is generally of the same material thickness and wherein said first and third edges are generally parallel to each other and wherein said first and third edges are generally perpendicular to said fourth edge and wherein said second edge is concave and generally v-shaped such that, when said side bracket is in its intended position relative to said rotary saw and said rotary saw mount, the v-shaped edge firmly contacts the circumference of the lower body said rotary saw and wherein said side bracket has a slot, hereafter referred to as the first slot, and wherein said side bracket has another slot, hereafter referred to as the second slot, and wherein said first slot is generally in close proximity to and generally parallel to said first edge and wherein said second slot is generally in close proximity to and generally parallel to said third edge and wherein said first slot and said second slot are approximately equal in length and wherein said first slot and said second slot are approximately bisected by an imaginary line passing through the midpoint of said first edge and the midpoint of said third edge and wherein said first slot and said second slot are spaced apart a distance that is approximately equal to the distance between said fourth hole and said sixth hole of said rotary saw mount such that said side bracket can be affixed in its desired position across said first end and said second end of said rotary saw mount utilizing said fourth hole and said sixth hole of said rotary saw mount and wherein another side bracket is mounted similarly on the opposing side of said rotary saw such that said side bracket can be affixed in its desired position across said first end and said second end of said rotary saw mount utilizing said fifth hole and said seventh hole of said rotary saw mount and wherein said v-shaped second edge is lined with a compressible material layer such that when side pressure is made to be applied by said side brackets to said rotary saw the compressible layer will aid in captivating said rotary saw.

19. The means for adapting a vacuum to said assembly of claim 3 wherein said means comprises a vacuum adapter base, a vacuum adapter cover, a vacuum adapter hose fitting, and a means for securing said vacuum adapter base and said vacuum adapter cover and said vacuum adapter hose fitting wherein said means for securing said vacuum adapter base and said vacuum adapter cover and said vacuum adapter hose fitting comprises a plurality of appropriately sized screws and a plurality of appropriately sized locknuts whereby said screws and locknuts firmly affix said vacuum adapter base and said vacuum adapter cover and said vacuum adapter hose fitting to the underside of said work support element.

20. The vacuum adapter base of claim 19 wherein said base is of one-piece construction and wherein said base works in concert with said rotary saw mount to provide a plenum for exiting air flow resulting from the use of a vacuum cleaner to remove cuttings and wherein said base has an edge, hereafter referred to as the first edge, and wherein said base has another edge, hereafter referred to as the second edge, and wherein said base has another edge, hereafter referred to as the third edge, and wherein said base has another edge, hereafter referred to as the fourth edge, and wherein said first and second and third and fourth edges are generally of the same material thickness and wherein all of said base is generally of the same material thickness and wherein said first and third edges are generally parallel to each other and wherein said second and fourth edges are generally parallel to each other and wherein said first and third edges are generally perpendicular to said second and fourth edges and wherein said second and fourth edges are generally longer than said first and third edges and wherein said base contains a large diameter hole, hereafter referred to as the first hole, that is approximately centered between said second and fourth edges and wherein said first hole is adjoined with a slot shaped void, hereafter referred to as a slot, that together form a generally keyhole shaped void and wherein said slot is of generally constant width and wherein said slot is centered about an imaginary radial that originates at the center of said first hole and that is generally perpendicular to said third edge and wherein said slot extends through said third edge such that a center section of said third edge is removed and wherein said slot is generally the same width as said slot in said rotary saw mount and wherein said base is made to be mounted adjacent to said rotary saw mount such that said slots of said base and said rotary saw mount are aligned with each other thereby creating one continuous slot between said first hole of said base and said first hole of said rotary saw mount and wherein said base has another hole, hereafter referred to as the second hole, and wherein said base has another hole, hereafter referred to as the third hole, and wherein said base has another hole, hereafter referred to as the fourth hole, and wherein said base has another hole, hereafter referred to as the fifth hole, and wherein said second hole and said third hole and said fourth hole and said fifth hole are generally the same diameter and also of a lesser diameter than said first hole and wherein said second hole and said third hole and said fourth hole and said fifth hole are all located approximately on the corners of an imaginary square and wherein each side of said imaginary square is generally parallel to an edge of said base and wherein said second hole and said third hole and said fourth hole and said fifth hole are generally aligned with corresponding holes in each of said work support element, a vacuum adapter cover, and a vacuum adapter hose fitting and wherein said second hole and said third hole and said fourth hole and said fifth hole are each made to accept a suitable means for securing said base together with each of said work support element, a vacuum adapter cover, and a vacuum adapter hose fitting and wherein said base is positioned between said work support element and said vacuum adapter cover.

21. The vacuum adapter cover of claim 19 wherein said cover is of one-piece construction and wherein said cover works in concert with said vacuum adapter base to provide a cover for a plenum for exiting air flow resulting from the use of a vacuum cleaner to remove cuttings and wherein said cover has an edge, hereafter referred to as the first edge, and wherein said cover has another edge, hereafter referred to as the second edge, and wherein said cover has another edge, hereafter referred to as the third edge, and wherein said cover has another edge, hereafter referred to as the fourth edge, and wherein said first and second and third and fourth edges are generally of the same material thickness and wherein all of said cover is generally of the same material thickness and wherein said first and third edges are generally parallel to each other and wherein said second and fourth edges are generally parallel to each other and wherein said first and third edges are generally perpendicular to said second and fourth edges and wherein said second and fourth edges are generally longer than said first and third edges and wherein said cover contains a large diameter hole, hereafter referred to as the first hole, that is approximately centered between said second and fourth edges and wherein the center of said first hole is also located between said first edge and the midpoint of an imaginary line connecting the midpoints of said first edge and said third edge and wherein said cover has another hole, hereafter referred to as the second hole, and wherein said cover has another hole, hereafter referred to as the third hole, and wherein said cover has another hole, hereafter referred to as the fourth hole, and wherein said cover has another hole, hereafter referred to as the fifth hole, and wherein said second hole and said third hole and said fourth hole and said fifth hole are generally the same diameter and also of a lesser diameter than said first hole and wherein said second hole and said third hole and said fourth hole and said fifth hole are all located approximately on the corners of an imaginary square and wherein each side of said imaginary square is generally parallel to an edge of said base and wherein said second hole and said third hole and said fourth hole and said fifth hole are generally aligned with corresponding holes in each of said work support element, a vacuum adapter base, and a vacuum adapter hose fitting and wherein said cover has another large diameter hole, hereafter referred to as the sixth hole, that is approximately centered between said second and fourth edges and wherein the center of said sixth hole is also located between said third edge and the midpoint of an imaginary line connecting the midpoints of said first edge and said third edge and wherein the diameter of said sixth hole is of sufficient size to allow said first diameter of said adapters to slideably fit in said sixth hole when said cover is mounted in its intended position and wherein the diameters of said first hole and said sixth hole are approximately equal and wherein said cover has another hole, hereafter referred to as the seventh hole, and wherein said cover has another hole, hereafter referred to as the eighth hole, and wherein said seventh hole and said eighth hole are of approximately the same diameter and wherein the centers of said seventh hole and said eighth hole are located on an imaginary line that passes approximately through the center of said sixth hole and that is approximately perpendicular to said second edge and wherein said seventh hole and said eighth hole are generally separated by a distance approximately equal to the distance between said second and third holes of said rotary saw mount and wherein said seventh hole and said eighth hole are otherwise positioned within said cover such that said seventh hole and said eighth hole line up with said second and third holes of said rotary saw mount and wherein said second hole and said third hole and said fourth hole and said fifth hole are each made to accept a suitable means for securing said cover together with each of said work support element, a vacuum adapter base, and a vacuum adapter hose fitting and wherein said cover is positioned between said base and said vacuum adapter hose fitting and wherein said seventh hole and said eighth hole are each made to accept a suitable means for securing said cover together with said rotary saw mount.

22. The vacuum adapter hose fitting of claim 19 wherein said hose fitting is of one-piece construction and wherein said hose fitting has a tubular section and wherein said tubular section is of a length and diameter to allow mating to a vacuum hose and wherein said hose fitting has a flange at one end of said tubular section and wherein said flange has four edges that generally form a square and wherein said hose fitting contains a hole in one comer of said flange, hereafter referred to as the first hole, and wherein said hose fitting contains another hole in another comer of said flange, hereafter referred to as the second hole, and wherein said hose fitting contains another hole in another comer of said flange, hereafter referred to as the third hole, and wherein said hose fitting contains another hole in another comer of said flange, hereafter referred to as the fourth hole, and wherein the center of said first hole and the center of said second hole and the center of said third hole and the center of said fourth hole are each located approximately on the corners of an imaginary square and wherein each side of said imaginary square is approximately parallel to an edge of said flange and wherein said first hole and said second hole and said third hole and said fourth hole are all approximately the same size and wherein said first hole and said second hole and said third hole and said fourth hole are each made to accept a suitable means for securing said hose fitting together with each of said work support element, a vacuum adapter base, and a vacuum adapter cover and wherein said hose fitting is positioned below said vacuum adapter cover such that a suitable vacuum hose can be properly attached to said hose fitting.
